(19) United States
(12) Patent Application Publication
(10) Pub. No.: US 2024/0346361 A1
(43) Pub. Date: Oct. 17, 2024

(54) AUTOMATIC SIGNAL CLUSTERING WITH AMBIENT SIGNALS FOR ML ANOMALY DETECTION

(71) Applicant: ORACLE INTERNATIONAL CORPORATION, Redwood Shores, CA (US)

(72) Inventors: Keyang RU, Kirkland, WA (US); Kuei-Da LIAO, Newark, CA (US); Matthew T. GERDES, Oakland, CA (US); Kenny C. GROSS, Escondido, CA (US); Guang Chao WANG, San Diego, CA (US); Ruixian LIU, San Diego, CA (US)

(21) Appl. No.: 18/133,047

(22) Filed: Apr. 11, 2023

(51) Int. Cl. G06N 20/00

(52) U.S. Cl. CPC G06N 20/00

(57) ABSTRACT

Systems, methods, and other embodiments associated with automatic clustering of signals including added ambient signals are described. In one embodiment, a method includes receiving time series signals (TSSs) associated with a plurality of machines (or components or other signal sources). The TSSs are unlabeled as to which of the machines the TSSs are associated with. The TSSs are automatically separated into a plurality of clusters corresponding to the plurality of the machines. A group of ambient TSSs is identified that overlaps more than one of the clusters. The group of the ambient TSSs is added into the one cluster of the clusters that corresponds to the one machine. A machine learning model is then trained to detect an anomaly based on the one cluster to generate a trained machine learning model that is specific to the one machine without using the TSSs not included in the one cluster.

### BACKGROUND

Sensors for a wide variety of physical phenomena may be affixed to machines, devices, systems, or facilities (collectively referred to as “assets”). The sensors gather time series data about the physical phenomena occurring in or around an asset. Many tens or hundreds of thousands of sensors may be used to obtain the time series data. The time series data collected by the sensors may be monitored or analyzed by computers.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of an automatic clustering system associated with automatic signal clustering with ambient signals for ML anomaly detection.

FIG. 2 illustrates one embodiment of an automatic clustering method associated with automatic signal clustering with ambient signals for ML anomaly detection.

FIG. 3 illustrates another embodiment of an automatic clustering method associated with automatic signal clustering with ambient signals for ML anomaly detection.

FIG. 4 illustrates one embodiment of a gap statistic analysis of clusters that is associated with automatic signal clustering with ambient signals for ML anomaly detection.

FIG. 5 illustrates one example of selection of an optimal or correct number of clusters based on gap statistics.

FIG. 6 illustrates one embodiment of a parametric cross-correlation global variable isolation process 600 that is associated with automatic signal clustering with ambient signals for ML anomaly detection.

FIG. 7 illustrates an embodiment of a computing system configured with the example systems and/or methods disclosed.

### DETAILED DESCRIPTION

Systems, methods, and other embodiments are described herein that provide for automatic signal clustering with ambient signals for ML anomaly detection. In one embodiment, an automatic clustering system automatically separates unlabeled time series signals into clusters that correspond to an unspecified number of components of an asset. Then, the automatic clustering system picks out a group of ambient signals that are applicable across multiple components and includes a copy of the group of ambient signals in the separate clusters. In one example, time series signals that are specific to components of an asset are autonomously clustered based on correlated activity of the signals in a time domain. In one example, ambient signals are automatically chosen based on correlation of signals between clusters. Each cluster may then be used to train an ML anomaly detection model that is specific to one of the discrete components.

In one embodiment, the automatic clustering system automatically derives the initially unspecified number of components of the asset and the clusters of signals associated with the components from the unlabeled time series signals. The automatic clustering system automatically identifies the number of components (and corresponding clusters) using a gap statistic analysis of the time series signals. The gap statistic analysis also places the signals associated with a component of the asset into a cluster corresponding to the component of the asset. And, in one embodiment, the automatic clustering system automatically identifies which of the signals are ambient signals that influence more than one of the components by finding the signals in each cluster that are most correlated with signals in other clusters.

For example, the automatic clustering system may be presented with a time series database of unlabeled signals from an aircraft. The automatic clustering system will automatically identify how many components (such as engines, pumps, motors, etc.) are represented in the time series database, automatically place the signals associated with each component or related components into one cluster, automatically identify ambient time series signals (such as measurements of airspeed or external temperature), and add copies of the ambient time series signals into each cluster. In one embodiment, automatic clustering of signals as described herein improves the technology of ML anomaly detection by enabling ML models to be trained on clusters specific to asset components, even when the components or component inter-correlations are not specified in advance of training. In one embodiment, automatic clustering of signals as described herein improves the technology of ML anomaly detection by enabling ML models to reduce compute and memory requirements by using fewer signals while improving prognostic accuracy (with fewer false alarm probabilities and fewer missed alarm probabilities) because the signals retained for use with the ML model are automatically identified to be relevant. Other improvements to the technology of ML anomaly detection are described herein.

### Definitions

As used herein, the term “time series” refers to a data structure in which a series of data points (such as observations or sampled values) are indexed in time order. In one embodiment, the data points of a time series may be indexed with an index such as a point in time described by a time stamp and/or an observation number. As used herein, the terms “time series signal” and “time series” are synonymous, and occasionally a time series signal may also be referred to herein as simply a “signal”. For example, a time series is one “column” or sequence of observations over time from one of several variables for a transaction.

As used herein, the term “vector” refers to a data structure that includes a set of data points (such as observations or sampled values) from multiple time series at one particular point in time, such as a point in time described by a time stamp, observation number, or other index. For example, a “vector” is one row (timestamp) of observations from all N variables involved in a transaction (e.g., including both input variables that describe the transaction and categorical variables that describe the person).

As used herein, the term “time series database” refers to a data structure that includes one or more time series that share an index (such as a series of points in time, time stamps, time steps, or observation numbers) in common. As an example, time series may be considered “columns” of a time series database, and vectors may be considered “rows” of a time series database. For example, a database or collection of transactions may be arranged or indexed in order of a recorded time for the transaction, thus making a time series database of the transactions.

As used herein, the term “residual” refers to a difference between a value (such as a measured, observed, sampled, or resampled value) and an estimate, reference, or prediction of what the value is expected to be. For example, a residual may be a difference between an actual, observed value and a machine learning (ML) prediction or ML estimate of what the value is expected to be by an ML model. In one embodiment, a time series of residuals or “residual time series” refers to a time series made up of residual values between a time series of values and a time series of what the values are expected to be.

As used herein, the term “clustering” refers to dividing a set of time series signals into subsets, referred to as “clusters”, that have a high degree of intercorrelation (or more generally, “similarity”) within the subset. For example, an aircraft may have four engines, which may be operated at different speeds or otherwise have characteristics unique to the engine. Time series of sensor data from the engines may be clustered into four subsets of signals that respectively represent the four engines. The clusters of time series signals sets for individual engines can then be monitored for anomalous behavior.

As used herein, the term “signal source” refers to a machine, device, piece of equipment, apparatus, or component that is a member or constituent piece of an asset or system, and which may operate or be operated in a manner that is not correlated with operation of other members or constituent pieces of the asset or system. For example, an individual engine, hydraulic pump, and fuel pump (which are constituent parts of an aircraft asset) may each be a signal source. Or, for example, individual transformer units (which are constituent parts of an electrical substation asset, and of a utility grid system) may each be a signal source. Where the terms “machine,” “device,” “piece of equipment,” “apparatus,” “component,” or “asset component” is used herein to describe a device that is monitored with sensors as a source of signals, others of the foregoing terms can be substituted.

It should be understood that no action or function described or claimed herein is performed by the human mind. No action or function described or claimed herein can be practically performed in the human mind. An interpretation that any action or function described or claimed herein can be performed in the human mind is inconsistent with and contrary to this disclosure.

### —Example Automatic Clustering System—

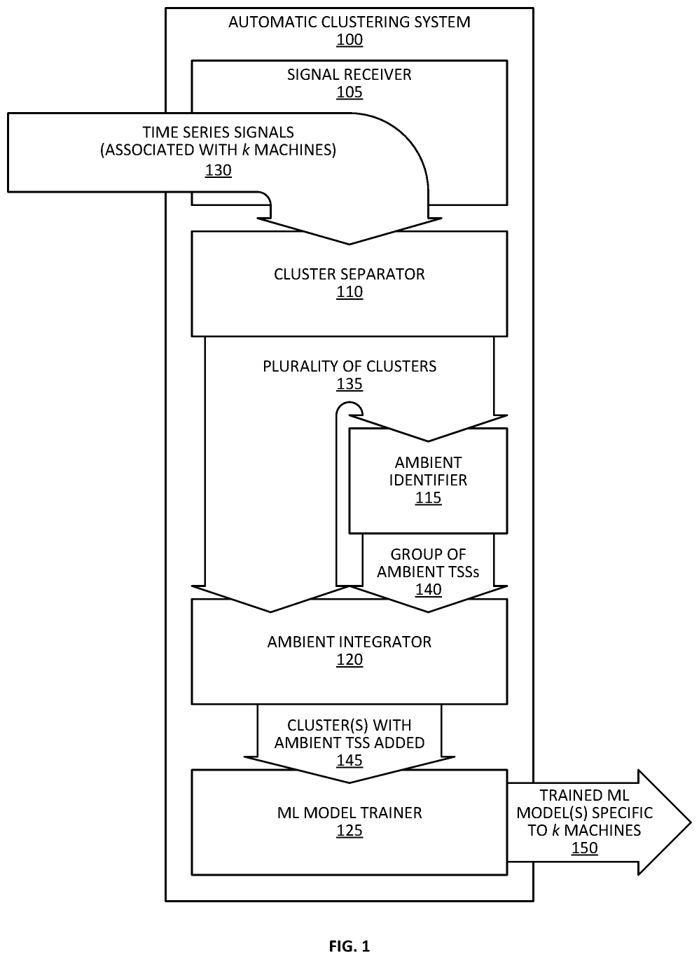

FIG. 1 illustrates one embodiment of an automatic clustering system 100 associated with automatic signal clustering with ambient signals for ML anomaly detection. Automatic clustering system 100 includes components for generating ML anomaly detection models that are specific to particular machines (or asset components, devices, or other signal sources) where the number of machines is unknown and a collection of time series signals representing the machines are not labeled with the machine from which the time series signal is obtained. In one embodiment, automatic clustering system 100 causes the resulting trained ML anomaly detection models to detect anomalies with improved accuracy.

The components of automatic clustering system 100 include a signal receiver 105, a cluster separator 110, an ambient identifier 115, an ambient integrator 120, and an ML model trainer 125. In one embodiment, signal receiver 105 is configured to receive time series signals 130 that are associated with an unspecified number k of machines (or asset components, devices, or other signal sources). The time series signals 130 are unlabeled as to which of the k machines the time series signals 130 are associated with. In one embodiment, cluster separator 110 is configured to automatically separate the time series signals 130 into a plurality of clusters 135. The plurality of clusters 135 correspond to the number of the machines. One cluster of the plurality of clusters 135 corresponds to one machine of the k machines and includes a subset of the time series signals 130 that are associated with the one machine of the k machines.

In one embodiment, ambient identifier 115 is configured to identify a group of ambient time series signals 140 that overlaps more than one of the clusters in the plurality of clusters 135. The group of ambient time series signals can often contain only one signal but also can contain more. In one embodiment, ambient integrator 120 is configured to add the group of the ambient time series signals 140 into one or more of the plurality of clusters 135, producing one or more clusters with ambient TSS added 145. For example, ambient integrator 120 is configured to add the group of the ambient time series signals 140 into the one cluster of the clusters that corresponds to the one machine.

In one embodiment, ML model trainer 125 is configured to train a machine learning model to detect an anomaly based on the one cluster (with ambient TSS added) 145. ML model trainer 125 thus generates a trained machine learning model 150 that is specific to the one machine without using the time series signals not included in the one cluster (with ambient TSS added) 145. In one embodiment, ML model trainer 125 is configured to generate trained machine learning models 150 specific to more than one, or all, of the k machines represented in the time series signals 130.

In one embodiment these components 105, 110, 115, 120, and 125 of automatic clustering system 100 may be implemented as software executed by computer hardware. For example, components 105, 110, 115, 120, and 125 may be implemented as one or more intercommunicating software modules, routines, or services for performing the functions of the components.

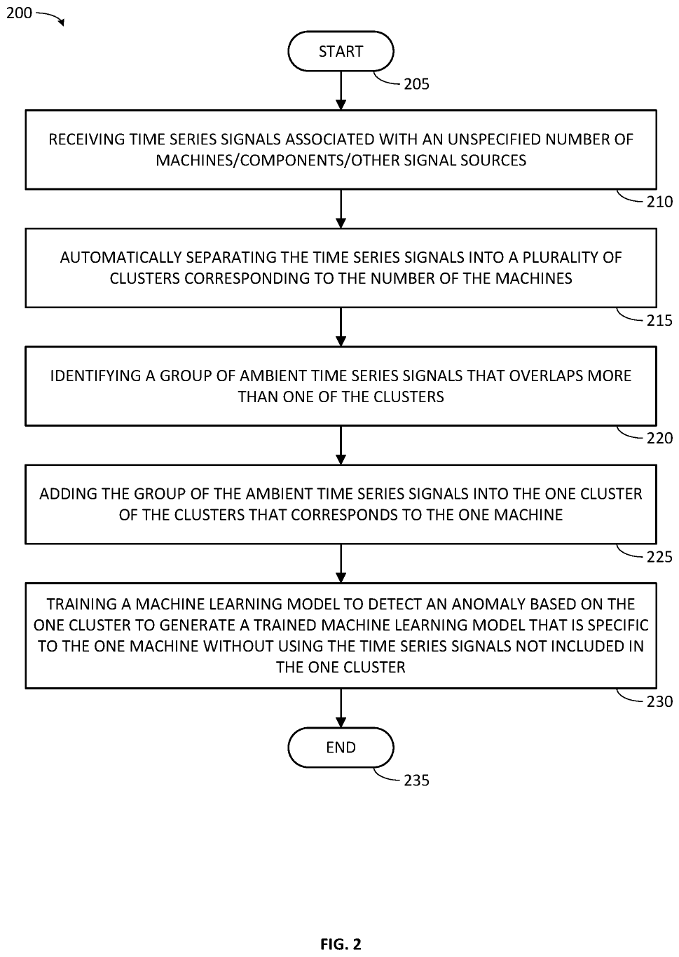

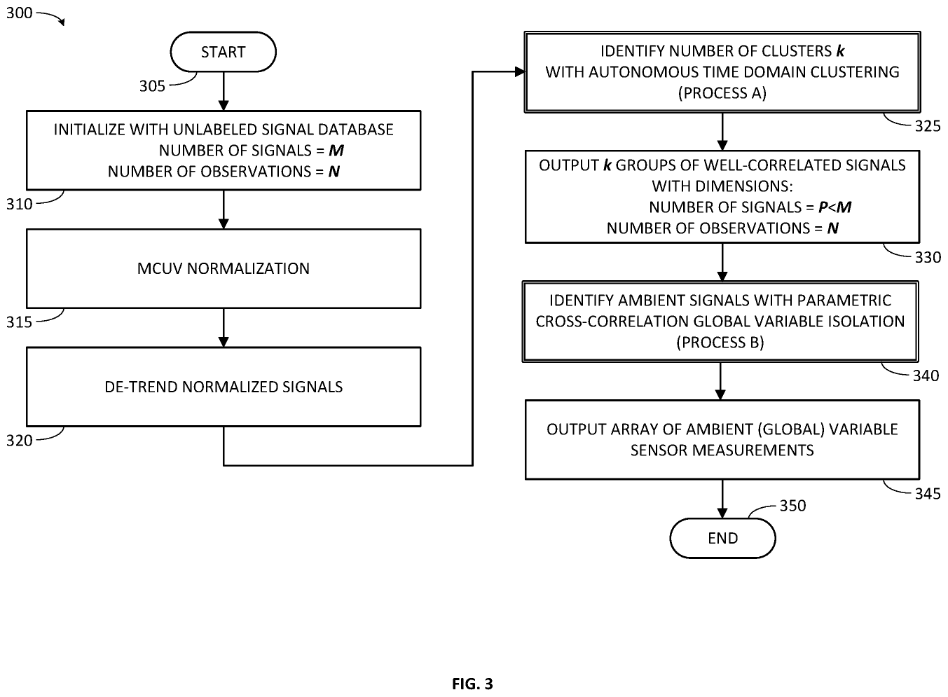

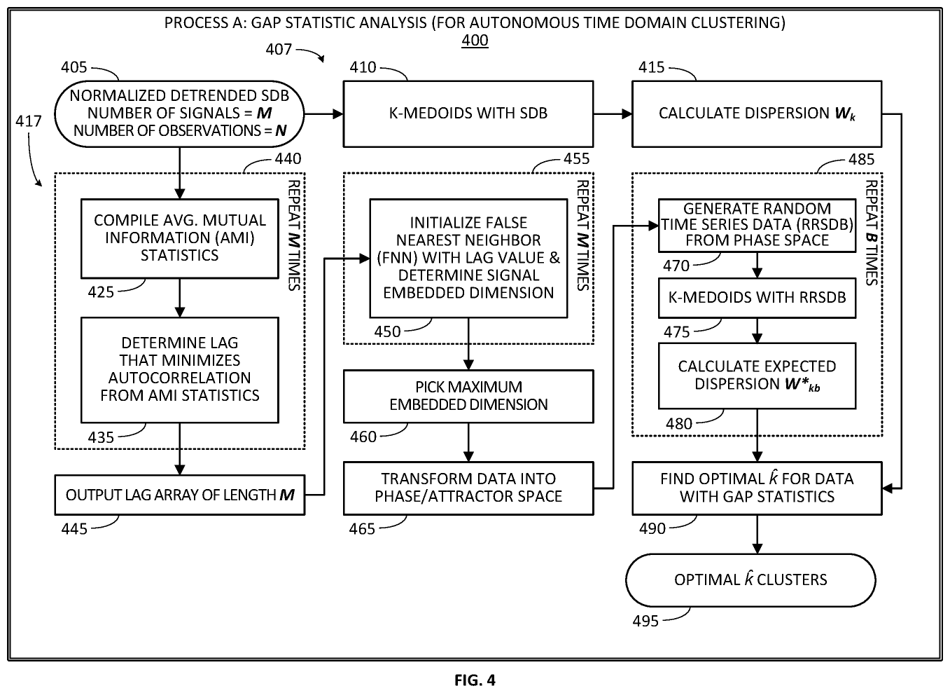

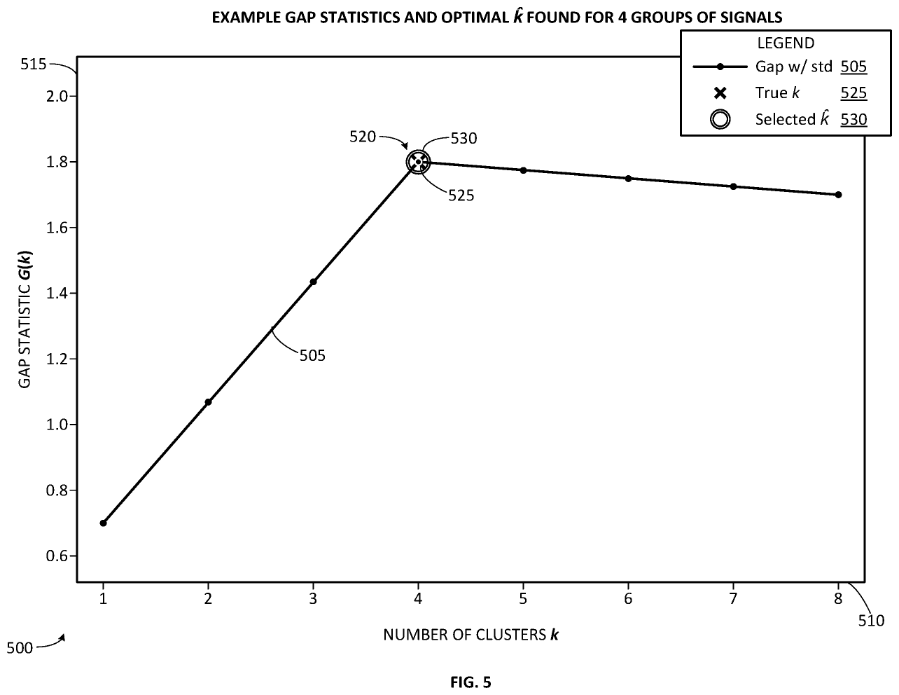

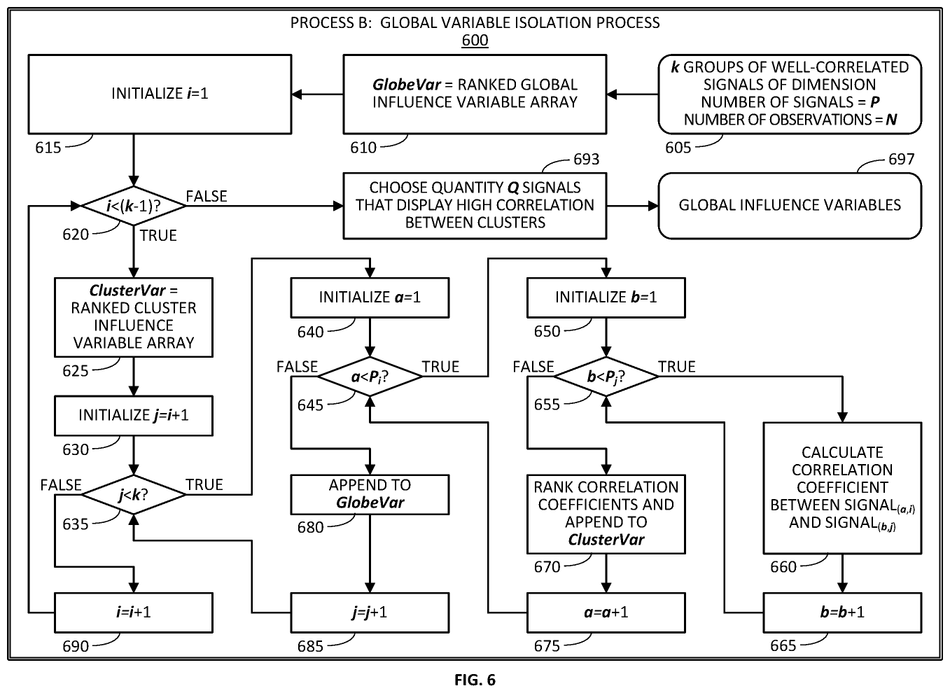

Further details regarding automatic clustering system 100 are presented herein. In one embodiment, the operation of automatic clustering system 100 will be described with reference to example automatic clustering methods 200 and 300 shown in FIGS. 2 and 3, respectively. In one embodiment, a gap statistic analysis for automatically separating signals into clusters associated with underlying equipment will be described with reference to FIGS. 4 and 5. In one embodiment, a global (ambient) variable isolation process for identifying ambient signals in the clusters that have relevance across multiple clusters will be described with reference to FIG. 6.

### —Example Automatic Clustering Method—

FIG. 2 illustrates one embodiment of an automatic clustering method 200 associated with automatic signal clustering with ambient signals for ML anomaly detection. As an overview, in one embodiment, automatic clustering method 200 automatically separates clusters of time series signals that that are associated with individual machines (or asset components or other signal sources) out of a set of unlabeled time series signals. Then, automatic clustering method 200 adds back into the clusters a collection of time series signals for ambient or global influences on the machines that were distributed among the clusters. These machine-specific clusters that include a full set of the ambient time series signals are then used to train machine-specific ML anomaly detection models.

In one embodiment, automatic clustering method 200 initiates at START block 205 in response to an automatic clustering system (such as automatic clustering system 100) determining one or more of (i) that an automatic clustering system has received or has begun receiving a set of time series signals/readings; (ii) that an instruction to perform automatic clustering method 200 on a set of time series signals/readings has been received (iii) a user or administrator of an automatic clustering system has initiated automatic clustering method 200; (iv) it is currently a time at which automatic clustering method 200 is scheduled to be run; or (v) that automatic clustering method 200 should commence in response to occurrence of some other condition. In one embodiment, a computer system configured by computer-executable instructions to execute functions of automatic clustering system 100 executes automatic clustering method 200. Following initiation at start block 205, automatic clustering method 200 continues to process block 210.

### —Example Method-Receiving Unlabeled Signals From Unspecified Machines—

At process block 210, automatic clustering method 200 receives time series signals associated with a plurality of machines, asset components, or other signal sources. In one embodiment, the plurality is an unspecified number of machines, asset components, or other signal sources. In one embodiment, no accurate count or number of the plurality of machines is received. In one embodiment, the signal sources that the time series signals are associated with are not identified from labels of the time series signals. In one embodiment, the time series signals are unlabeled as to which of the machines, asset components, or other signal sources the time series signals are associated with. For example, the time series signals may include time series signals from various constituent devices of an aircraft, such as from separate engines, hydraulic systems, fuel pumps, and other aircraft systems, but have no labels that specifically associate the signals with the components of the aircraft.

The time series signals may be received from sensors, such as Internet-of-things (IoT) or other sensors that communicate directly or indirectly with automatic clustering system 100. The sensors may be positioned in, on, proximate to, or otherwise sufficiently near to a machine, asset component, or other signal source to detect physical phenomena generated by operation of the machine, asset component, or other signal source. The sensors are configured to sense physical phenomena occurring in and/or around machines, components of assets, or other signal sources. The sensors transduce the physical phenomena in locations associated with the machines, asset components, or other signal sources to generate a time series of measured values for the phenomena that are associated with the machine, asset component, or other signal source. The time series signals are thus generated by sensors. The machines, asset components, or other devices that generate the physical phenomena detected by the sensors are therefore sources of the time series signals. The sensors (or intermediate systems) transmit the time series signals to the automatic clustering system 100.

Generally, the time series signals received from the sensors are non-stationary or dynamic. That is, the time series signals change in value over time. Changes in the time series signals represent changes in operation of the signal source. Individual time series signals may exhibit serial correlation (or autocorrelation), that is, a similarity in pattern of change in value over time between one time range of a signal and another (e.g., later) time range of the signal, such as may be caused by repeated or cyclic activity of a signal source of the time series signal. Two or more time series signals may exhibit cross correlation, that is, a similarity in pattern of change in value over time between one time series signal and another time series signal, as may be caused by the two time series signals sharing one signal source.

In one embodiment, receiving the time series signals may include accepting live, real-time signals from sensors monitoring a machine, asset component, or other source of signals. In one embodiment, receiving the time series signals includes placing signals into memory or storage for subsequent processing. In one embodiment, receiving the time series signals includes retrieving or accessing the signals from memory or storage. In one embodiment, automatic clustering system 100 may parse the time series signal to extract values.

A time series signal is associated with a machine, asset component, device, or other signal source when the time series signal is generated by a sensor that configured to capture readings of physical phenomena produced by operation of the machine, asset component, device, or other signal source. In other words, a time series signal that is associated with signal source represents operation or activity of the signal source. For example, one time series signal may describe operation of an engine as a series of time-indexed vibration sensor readings, another time series signal may describe the operation of the engine as a series of time-indexed temperature readings, and yet another time series signal may describe the operation of the engine as a series of time indexed fuel consumption readings.

In practice, the time series signals generated by the sensors are unlabeled (that is, not labeled) as to which of a set of components (or other signal sources) the signals are associated with. In one embodiment, lack of labeling includes situations where the time series signals are practically unlabeled—that is, the signals are labeled in a manner that would require domain knowledge (of the specific asset and sensor configuration) or a key to establish the association between signals and the components. For example, an aircraft may have vibration sensors associated with various engines, pumps, blowers, or other components of the aircraft, but may be labeled numerically, e.g., vibration sensor signals 0001-5500. In other words, time series signals are unlabeled as to which of the machines, asset components, devices, or other signal sources that they are associated with where the signal does not identify a signal source that is producing the physical phenomena represented by the signal.

In one embodiment, a collection or set of time series signals (such as a time series database) may be considered to be unlabeled with respect to signal source when some time series signals in the set are labeled with respect to signal source, while other time series signals are not. For example, some vibration sensors associated with engine 1 of an aircraft may be labeled as vibration sensors for engine 1, while other vibration sensors that are in, on, or otherwise proximate to engine 1 (and therefore sense vibrations produced by engine 1) may nevertheless not be assigned to engine 1 in a labeling scheme.

Generally, a collection of time series signals received represents overall operation of an asset or system. In practice, the number of constituent machines, components, or other signal sources in the asset represented by the collection of time series signals may be unknown at the time the time series signals are received. For example, the number and nature of the signal sources are not specified or are otherwise hidden from the automatic clustering system. An accurate count of signal sources may be unavailable or otherwise not provided to the automatic clustering system. The number or count of signal sources is thus not pre-established or known to the automatic clustering system in advance. This lack of information as to the constituent signal sources in the overall asset may be due, for instance, to due to lack of signal labeling and/or lack of description of what the sensed asset is. The number or count of signal sources is thus left ambiguous or unexpressed. In other words, the time series signals are associated with an unspecified number of constituent signal sources for an asset.

Time series signals from multiple signal sources are intermixed together in the collection of time series signals. For example, the time series signals are collectively grouped together without pre-defined labels as to signal source or other assignment to particular signal sources. Time series signals from multiple signal sources (e.g., discrete machines or components) may be intermixed without attribution to particular signal sources. The time series signals may be collected simultaneously from multiple separate or discrete machines, components, or other signal sources, and delivered blended together in no particular order as a combined collection, group, or set. The time series signals in the set represent the operation of multiple components of an asset, but how many components are represented is not described by the time series signals or by other information presented to the automatic clustering system 100. The number of machines, asset components, devices, or other signal sources included in the received group of time series signals is left to be discovered or identified from the time series signals themselves. For example, a collection of time series signals produced by an aircraft may simply be numbered, signal numbers 1-70,000, or otherwise not state how many discrete, independently operating component devices such as engines, pumps, blowers, etc. are represented by the signals.

In one embodiment, the number or count of the plurality of machines, components, or other signal sources represented in the time series is unspecified because the number of signal sources (and quantity of corresponding clusters) is to be discovered or inferred from the time series signals themselves. For example, as discussed later herein, a “correct” quantity of clusters that accurately corresponds to the machines is reached by automatic clustering method 200 even where the number or count of the plurality of machines is not known or not expressly provided. Or, for example, even where an inaccurate count of machines in the plurality is provided as an express input, automatic clustering method 200 can be used to override, replace, or otherwise correct the inaccurate number of machines with an accurate number that is derived from the time series signals.

Thus, in one embodiment, automatic clustering method 200 receives time series signals associated with a plurality of machines by accepting transmissions of the time series signals from sensors associated with multiple signal sources in an asset, and placing the time series signals into memory or storage for subsequent processing. At the conclusion of process block 210, automatic clustering method 200 has a collection of unlabeled time series signals from an unspecified number of signal sources. In one embodiment, the functions of process block 210 are performed by signal receiver 105 of automatic clustering system 100.

### —Example Method-Automatic Separation Into Clusters—

At process block 215, automatic clustering method 200 automatically separates the time series signals into a plurality of clusters corresponding to the number of the machines. In one embodiment, one cluster of the clusters corresponds to one machine of the machines and includes the time series signals that are associated with the one machine of the machines. In one embodiment, automatic clustering method 200 automatically discovers clusters of the time series signals that correspond to the signal sources. In one embodiment, automatic clustering method 200 determines an actual or correct number of the signal sources that are represented in the time series signals, and divides the time series signals into as many clusters. In one embodiment, automatic clustering method 200 automatically determines from the time series signals a plurality of clusters that correspond to the plurality of machines, components, or other signal sources, and separates the time series signals into the plurality of clusters. The determination and separation may be performed together based on correlated activity in the time series signals, for example in a gap statistic analysis. As a major improvement to the technology of prognostic anomaly detection, automatic clustering method 200 automatically determines the number of clusters by automatically identifying the actual number of signal sources based on information in the time series signals themselves, and does not need the number or count of clusters to be specified in advance.

A cluster is a separate subset of the time series signals. In one embodiment, automatic clustering method 200 automatically isolates or segregates the time series signals into a plurality of (that is, more than one) clusters. The time series signals are divided into clusters that correspond to the signal sources in a one-to-one correspondence, in which one cluster includes the signals associated with one signal source. A cluster corresponds to a signal source (and a signal source corresponds to a cluster) where the signals of the cluster exhibit correlated activity that represents the operation of the signal source. Thus, in one embodiment, one cluster in a set of the clusters will include the time series signals that are associated with one machine (or other signal source) in the set of machines. The cluster need not be labeled with the signal source (for example, labeling the cluster of signals associated with engine 1 of an aircraft as “engine 1” is not needed) in order for the cluster to correspond to the signal source.

In one embodiment, automatic clustering method 200 operates automatically or autonomously to create separate clusters based on the time series signals alone, without additional input to specify how many clusters should be created. In one embodiment, the actual or correct number of the signal sources and their corresponding clusters k is determined automatically based on correlations between time series signals themselves. Further, time series signals from a signal source are automatically assigned to a cluster corresponding to the signal source based on the correlations. In this way, automatic clustering method 200 automatically detects which of the time series signals are associated with individual signal sources. In other words, automatic clustering method 200 identifies a correct number of clusters k without an end user of having to know k in advance. In one embodiment, automatic clustering method 200 more accurately associates signals with a particular machine (or other signal source) so that accurate ML models can be trained for the particular machine.

In one embodiment, the automatic discovery of the correct number of clusters k and signal assignment are performed by a gap statistic analysis. At a high level, in one embodiment, the gap statistic analysis automatically chooses the correct number of clusters k by finding an arrangement of the signals into clusters in which correlations between signals within single clusters (also referred to as “intra-cluster correlations”) are maximized, and correlations between signals that are in separate clusters (also referred to as “inter-cluster correlations”) are minimized. In summary, in one embodiment, the gap statistic analysis iteratively determines a gap statistic for incrementally increasing values for the number of clusters k. The gap statistic is a difference between (i) intra-cluster dispersions for placing the time series signals into k clusters and (ii) intra-cluster dispersions for placing time series signals of random values into k clusters. The number of clusters k at which the value of the gap statistic is maximized is the actual or correct number of the signal sources and their corresponding clusters k, and the arrangement of signals into the k clusters (initially performed in order to generate the gap statistic) accurately places signals from a signal source into a cluster associated with the signal source. Thus, clustering of the signals takes place in the calculation of gap statistics. The gap statistic analysis is shown and described in additional detail with reference to FIGS. 4 and 5 under the heading “First Phase: Gap Statistic Analysis of Clusters”.

A cluster of signals that are associated with an individual machine (or asset component or other signal source) may be used for training an ML anomaly detection model that is specific to the individual machine. In one embodiment, automatic clustering method filters the time series signals to create the clusters. In one embodiment, a cluster generated for one signal source in accordance with the automatic clustering method 200 (i) includes a subset of the time series signals that are relevant to the one signal source and (ii) excludes time series signals that are not relevant to the one signal source. In this way, automatic clustering method filters out time series signals that are not associated with the one signal source in order to create a cluster that is specific to the one signal source. Automatic clustering method 200 thus separates time series signals for one machine (or other signal source) from time series signals for another machine (or other signal source). In one embodiment, a cluster of signals for one signal source may be stored separately from clusters of signals for other signal sources. For example, a cluster of signals for one signal source may be stored in a discrete data structure apart from clusters of signals for other signal sources.

In one embodiment, a cluster generated for one signal source in accordance with the automatic clustering method 200 reduces the quantity of time series signals that are used for training the ML anomaly detection model. The smaller quantity of signals included in cluster generated for one signal source in accordance with the automatic clustering method 200 provides multiple improvements to the field of prognostic anomaly detection. First, using the cluster results in increased prognostic accuracy of ML models for the signal source because signals relevant to operation of the signal source are automatically retained, while irrelevant signals are automatically excluded. The time series signals retained in a cluster for the one signal source are cross-correlated, and the correlated behavior of the signals in the cluster represent operation of the one signal source. Uncorrelated time series signals that are not relevant to the operation of the one signal source are not placed into the cluster, reducing irrelevant inputs that may obscure anomalous activity. Second, because the compute and memory costs of multivariate anomaly detection increase quadratically with the number of signals, ML anomaly detection models using the subset of signals included in a cluster are more computationally efficient than ML anomaly detection models using the whole set of time series signals.

Thus, in one embodiment, automatic clustering method 200 automatically separates the time series signals into a plurality of clusters corresponding to the number of the machines by analyzing the time series signals to determine which configuration of clusters maximizes intra-cluster correlations and minimizes inter-cluster correlations, and then storing the clusters of the determined configuration separately. At the conclusion of process block 215, automatic clustering method 200 has automatically determined which number of clusters correctly correlates with the number of machines, asset components, or other signal sources, and split the clusters of signals into clusters or groups of signals with correlated activity that are associated with the signal sources. The group of signals to be used for training ML models specific to individual machines, asset components thus includes fewer signals than the overall collection of time series signals. In one embodiment, the functions of process block 215 are performed by cluster separator 110 of automatic clustering system 100.

### —Example Method-Automatic Identification of Ambient Time Series Signals—

At process block 220, automatic clustering method 200 identifies a group of ambient time series signals that overlaps more than one of the clusters. Time series signals for sensors that detect ambient or global conditions that apply across more than one (or all of) of the machines, asset components, or other signal sources may be referred to herein as ambient time series signals. In one embodiment, the ambient time series signals represent physical phenomena that influence multiple signal sources, such as environmental factors like temperature, barometric pressure, altitude, humidity, etc. In one embodiment, the ambient time series signals describe an influence external to or from outside of the asset or system. In one embodiment, the ambient time series signals describe an upstream influence or dependency for the asset or system. In one embodiment, automatic clustering method 200 automatically identifies ambient time series signals based on inter-cluster correlations.

The ambient time series signals do not arise from the machines, asset components, or other signal sources, although they may initially be placed into clusters for signal sources at process block 215. The automatic separation into clusters performed at process block 215 operates based on intra-cluster correlation to assign the time series signals to clusters. But, because readings of global or ambient factors such as temperature may be somewhat influenced by the operation of the signal sources, the ambient time series signals will be distributed into the clusters based on the correlations. For example, a temperature sensor for ambient temperature may produce readings that are slightly affected by an engine temperature of an engine to which the temperature sensor is attached. The time series signal for ambient temperature may initially be clustered with other signals for the engine to which the ambient temperature sensor is attached due to slight correlation with the engine, but will be found to be an ambient variable due to a greater-than-threshold level of correlation with other ambient temperature sensor signals.

In one embodiment, a group of ambient time series signals that overlaps more than one of the clusters is detected and retrieved from the clusters by a global variable isolation process. The ambient time series signals may be identified from inter-cluster signal correlations between signals in more than one of the clusters. Time series signals that have been distributed to separate clusters may be automatically determined to be ambient time series signals based on the presence of sufficient inter-cluster correlation between a signals in one cluster and another signal in another cluster. The group of ambient time series signals overlaps or spans more than one cluster by having correlated members of the group in more than one cluster. Time series signals from one cluster are chosen to be ambient time series signals when they are highly correlated with one or more signals in another cluster(s). Time series signals that lack sufficient inter-cluster correlation are filtered out of and excluded from the ambient time series signals. In one embodiment, ambient time series signals are distinguished from time series signals associated with only one machine (or other signal source) based on complying with a threshold condition of correlation with signal(s) in other clusters.

At a high level, in one embodiment, the global variable isolation process recognizes those time series signals in the clusters that have an inter-cluster correlation that is above a threshold level (or otherwise satisfies a threshold). In summary, in one embodiment, the time series signal in each cluster are examined pairwise with the time series signals belonging to other clusters to determine an extent of inter-cluster correlation between each pair of signals belonging to separate clusters. The cross-correlation coefficient between one signal in one cluster and another signal in another cluster is found for each pair of signals from separate clusters. The cross-correlation coefficient is used as the measure of inter-cluster correlation. In one embodiment, the cross-correlation coefficient is the Pearson correlation coefficient. The highest cross-correlation coefficient for each signal is identified, for example by sorting the cross-correlation coefficients by size. The highest cross-correlation coefficient for each signal is then compared to a threshold. If the cross-correlation coefficient for a signal satisfies the threshold (for example by falling within a top percentile of correlation coefficients), the signal is added to a set of ambient time series signals. The threshold may be pre-defined by a user or administrator of automatic clustering system 100. The global (ambient) variable isolation process is shown and described in additional detail with reference to FIG. 6 under the heading “Second Phase: Global (Ambient) Variable Isolation”.

In one embodiment, the ambient time series signals found by the global variable isolation process are extracted from the clusters in which they were located, and added to a set of ambient time series signals. For example, the ambient time series signals may be stored in an array or other data structure of ambient time series signals. In one embodiment, the ambient signals are deleted from the clusters in addition to the ambient signals being extracted. The ambient signals are removed from the clusters to prevent duplication of the ambient signals because a complete copy of the set of the ambient signals will be added back into the clusters at process block 225.

Thus, in one embodiment, automatic clustering method 200 identifies a group of ambient time series signals that overlaps more than one of the clusters by finding inter-cluster cross-correlation coefficients between each pair of time series signals belonging to separate clusters, determining a greatest extent of inter-cluster correlation for each time series signal, comparing the greatest extent of inter-cluster correlation for each time series signal to a threshold, and, where the threshold is satisfied, adding the time series signal to a collection or set of ambient time series signals. At the conclusion of process block 220, automatic clustering method 200 has automatically identified the ambient time series signals based on the inter-cluster correlations of the ambient time series signals. In one embodiment, the functions of process block 220 are performed by ambient identifier 115 of automatic clustering system 100.

### —Example Method-Automatic Identification of Ambient Time Series Signals—

At process block 225, automatic clustering method 200 adds the group of the ambient time series signals into the one cluster of the clusters that corresponds to the one machine (or asset component, or other signal source). In one embodiment, a copy of the full set of ambient time series signals is added into multiple clusters, for example, into each of the clusters. Thus, the complete set of signals that were identified to be ambient is included in each of the clusters.

In one embodiment, one or more clusters that include signals that specifically represent operation of one machine (or asset component, or other signal source) will be supplemented with signals that represent external influences on the operation of the more than one of the machines (or asset components, or other signal sources). In one embodiment, the ambient time series signals in the array of ambient time series signals are appended to the data structure for each cluster. In one embodiment, duplicates of ambient signals are skipped, or the duplicates are removed, if the duplicates were not removed from the clusters in process block 220. The full set of ambient time series signals are thus included in the clusters.

Placing the collected ambient time series time signals into the cluster improves the technology of multivariate anomaly detection by ensuring that an ML anomaly detection model for a specific machine (or asset component, or other signal source) is provided with a set of the external influences on the specific machine. This results in further increases in prognostic accuracy beyond ML using the automatically separated clusters without addition of the ambient time series signals.

Thus, in one embodiment, automatic clustering method 200 adds the group of the ambient time series signals into the one cluster of the clusters that corresponds to the one machine by selecting the data structure for each cluster, and writing the ambient time series signals into the cluster. At the conclusion of process block 225, automatic clustering method 200 has added time series signals that describe the ambient (or global) conditions in which a machine operates to the cluster of signals that are specifically associated with the machine. In one embodiment, the functions of process block 225 are performed by ambient integrator 120 of automatic clustering system 100.

### —Example Method-Training of Machine Learning Model—

At process block 230, automatic clustering method 200 trains a machine learning model to detect an anomaly based on the one cluster to generate a trained machine learning model that is specific to the one machine without using the time series signals not included in the one cluster. For example, the cluster for a specific machine, as supplemented with the ambient signals, is used to configure an ML anomaly detection model to detect incorrect, improper, or otherwise anomalous operation of the specific machine.

In one embodiment, a machine learning model is assigned the time series signals in a cluster (including the ambient time series signals) as multivariate inputs of the machine learning model. The machine learning model parses the time series signals of the cluster (including the ambient time series signals) in an automatic training operation to adjust a configuration to cause the ML model to produce estimates consistent with the time series signals in the cluster. The training causes the machine learning model to produce estimates of what each signal in the cluster is expected to be based on the actual values of other signals. Differences or residuals between the estimates may be provided to a detection model such as SPRT to detect when deviations from expected signal values are anomalous. Additional detail on training of the machine learning model to detect an anomaly is provided below under the heading “Overview of Multivariate ML Anomaly Detection”.

Note that the trained ML model is specific to the machine, asset component, or other signal source that corresponds to the cluster. The ML model was trained only on signals of the cluster, which are either associated with the machine, asset component, or other signal source, or are an ambient influence on the machine, asset component, or other signal source. Other time series signals are filtered out when creating the cluster prior to training the ML model. This causes the ML model trained on the cluster automatically generated as described herein to exhibit improved prognostic accuracy. The ML model trained on the cluster automatically generated as described herein generates fewer false alarm probabilities (FAPs) and fewer missed alarm probabilities (MAPs) than an ML model trained with the entire collection of time series signals, than an ML model trained with an arbitrarily selected number of clusters, or than an ML model trained without including the ambient variables that overlap the clusters.

Thus, in one embodiment, automatic clustering method 200 trains a machine learning model to detect an anomaly based on the one cluster by selecting the one cluster that corresponds to the one machine and automatically configuring the machine learning model to generate estimates for the behavior of the one machine based on the time series signals included in the one cluster. Thus, a trained machine learning model that is specific to the one machine is generated without using the time series signals not included in the one cluster. In one embodiment, the functions of process block 230 are performed by ML model trainer 125 of automatic clustering system 100. Automatic clustering method 200 then concludes at END block 235.

At the conclusion of process block 230, automatic clustering method 200 has automatically generated a trained ML anomaly detection model that is specific to one machine, asset component, or other signal source. In one embodiment, trained machine learning models may be automatically produced for more than one of the machines (or all of the machines) represented in the time series signals. The ML anomaly detection model(s) may be automatically produced based on analysis of correlations of the signals, without reference to labels of the time series signals or inputs to indicate the number of discrete machines represented by the time series signals. In one embodiment, the resulting ML anomaly detection models are highly accurate due to exclusion of signals not relevant to modeling of the particular machine for which the ML model was created. In one embodiment, the resulting ML anomaly detection models use a minimal number of signals to completely represent the operation of and influences on a specific device, thereby reducing the compute burden of ML anomaly detection for the overall collection of time series signals.

### Further Embodiments of Example Automatic Clustering Method

In one embodiment, automatically separating the time series signals into the plurality of clusters corresponding to the plurality (or number) of machines as discussed above with reference to process block 215 further includes identifying a quantity for the plurality of the clusters at which intra-cluster correlations within the clusters are maximized and inter-cluster correlations between the clusters are minimized. In one embodiment, the number of the machines, asset components, or other signal sources is identified and set to be a quantity of the clusters for which intra-cluster correlations within the clusters are maximized and inter-cluster correlations between the clusters are minimized. In other words, the automatic clustering method 200 determines how many machines, asset components, or other signal sources represented by the unlabeled time series signals based on determining which number of clusters causes the time series signals to be most highly correlated with other signals within their own cluster, and causes the time series signals to be least correlated with other signals that are in other clusters. In this way, automatically determining from the time series signals the plurality of clusters that correspond to the plurality of machines identifies the quantity for the plurality of clusters at which intra-cluster correlations are maximized and inter-cluster correlations are minimized.

In one embodiment, automatically separating the time series signals into the plurality of clusters corresponding to the plurality (or number) of machines as discussed above with reference to process block 215 is based on a gap statistic analysis. For example, automatic clustering method 200 automatically determines from the time series signals the plurality of clusters that correspond to the plurality of machines based on the gap statistic analysis. Automatic clustering method 200 identifies intra-cluster dispersions in the plurality of clusters. The intra-cluster dispersions are identified based on determining the cross-correlation between a pair of signals that have undergone a convolution integral in time. For example, signal A is independently convolved with signal B, signal C, and itself, resulting in signal AB, signal AC, and signal AA, respectively. Subsequently, cross-correlation coefficient between signals AB and AA are determined. The process repeats for the cross-correlation between the convolution of signals AC and AA. The cross-correlation coefficient is then used to determine a distance between the pair of the time series signals. In one embodiment, the cross-correlation of each signal pair in a cluster is found, and the intra-cluster dispersion for the cluster is based on the collective distances of the signal pairs in the cluster.

Gap statistics for the clusters are then generated. Automatic clustering method 200 generates a gap statistic that indicates a difference between the first intra-cluster dispersions (in the clusters of actual signals) and other, intra-cluster dispersions in additional clusters of random noise signals. The gap statistic therefore indicates a difference between what an intra-cluster dispersion is for a quantity (or number) of clusters k of signals that are uncorrelated random noise and what an intra-cluster dispersion is for the quantity of clusters k of signals that are actually correlated. The quantity of clusters k of signals that shows the greatest difference from uncorrelated noise has greatest correspondence to the underlying actual number of machines, asset components, or other signal sources. Therefore, automatic clustering method 200 identifies or selects a quantity for the plurality of the clusters at which the gap statistic is maximized. Additional detail regarding the gap statistic analysis is described below with reference to FIGS. 4 and 5 under the heading “First Phase: Gap Statistic Analysis of Clusters”.

In one embodiment, the global, ambient, or common influence time series signals (discussed at process blocks 220-225) are sensor signals of physical phenomena not produced by the machines, asset components, or other signal sources. Thus, the ambient time series signals are not produced by the machines, asset components, or other signal sources. For example, the ambient time series signals may be temperature signals produced by outside air temperature, rather than produced by operation of an engine. In one embodiment, automatic clustering system 100 further includes a plurality of sensors from which the time series signals are received. In one embodiment, automatic clustering system 100 further includes one or more machines, assets, asset components, or other signal sources which generates one or more of the time series signals.

In one embodiment, the automatic clustering method 200 identifies a group of ambient time series signals that overlaps more than one of the clusters (as discussed above with reference to process block 220) by performing a global (or ambient) variable isolation process. Global variable isolation process operates to determine which of the time series signals distributed to the clusters are actually representative of global or ambient influences on the multiple machines, asset components, or other signal sources, in contrast to being representative of conditions for just one of the machines, asset components or other signal sources. In one embodiment, identifying the group of ambient time series that overlaps more than one of the clusters further includes automatically selecting signals from the time series signals that have an inter-cluster correlation between the more than one of the clusters that satisfies a threshold. In one embodiment, the automatic clustering method 200 isolates a subset of the time series signals as representing global or ambient variables that have a general influence on multiple clusters. This subset of time series signals may be referred to herein as ambient signals. For example, the ambient signals may be those that have a correlation with at least one signal in another cluster that falls within a range. For example, a time series signal that has a top-5% of value of correlation coefficient with signals in differing clusters may be identified as an ambient signal. Additional detail regarding the global variable isolation process is described below with reference to FIG. 6 under the heading “Second Phase: Global (Ambient) Variable Isolation”.

In one embodiment, the collection of signals identified as ambient signals in the various clusters may be then copied or otherwise added into a cluster, as discussed above at process block 225. In one embodiment, including a copy of the set of ambient signals in a cluster ensures that the ambient variables are fully considered by ML models trained on or executed on the cluster. In one embodiment, the collection of ambient signals may be copied to more than one of the clusters or all of the clusters. Thus, for each individual cluster in the plurality of clusters that corresponds to an individual machine, automatic clustering method 200 adds the ambient signals to the individual cluster and trains an ML anomaly detection model based on the cluster of signals combined with the ambient signals. Automatic clustering method 200 adds the group of the ambient time series signals to the individual cluster of time series signals associated with the individual machine. Automatic clustering method 200 trains a separate machine learning model that is specific to the individual machine, asset component, or other signal source that corresponds to the individual cluster, as discussed above with reference to process block 230. The machine learning model is trained to detect anomalies for the individual machine, asset component, or signal source based on the time series signals from the given cluster and the group of ambient time series signals. Additional detail regarding training of the machine learning model to detect anomalies, and regarding monitoring the cluster of signals to detect anomalies, is described herein under the heading “Overview of Multivariate ML Anomaly Detection”.

In one embodiment, once the machine learning model is trained, the machine learning model may be used to monitor the cluster of signals (including the ambient signals) for anomalous deviations from expected values. Thus, in one embodiment, following the training of the machine learning model at process block 230, automatic clustering method 200 monitors the cluster and, in response to detecting an anomaly, generates an electronic alert. Automatic clustering method 200 monitors the one cluster of the plurality of clusters of the time series signals with the trained machine learning model to detect the anomaly. In response to detecting the anomaly in the one cluster of the clusters of the time series signals, automatic clustering method 200 generates an electronic alert that the anomaly has occurred for the one machine of the machines that corresponds to the one cluster. Additional detail regarding the generation of an electronic alert is described herein under the heading “Electronic Alerts”.

### Discussion and Additional Embodiments

Cloud computing is rapidly increasing in ubiquity. But, with the advent of fifth generation mobile network (5G) technology and the diminishing size and cost of high-fidelity sensors, the capacity for the accumulation of data is outpacing processing power in the cloud. Moreover, the compute cost (and consequent pecuniary cost) of analyzing high-fidelity, sample-dense time series signals in the cloud can be exorbitant. For large-scale streaming Machine Learning (ML) use cases involving hundreds of thousands sensor signals, the compute cost can become substantially challenging to accommodate within the capacity of cloud containers (configurations of CPUs and/or available RAM configurations). It can be desirable to reduce the memory footprint of large-scale signals databases by subdividing the signals database into smaller sets of signals so that the signals databases can be stored more efficiently in smaller container shapes and reduces the throughput of signals.

When subdividing large-scale signals databases, it can be desirable to intelligently subdivide the signals into well-correlated “clusters” of signals, so that the clusters can be monitored in parallel. There exist approaches to subdivide the large-scale data to a number of clusters based on the correlations or “similarity” between time series signals. But the existing approaches were designed for use cases where subject matter experts (SMEs) know from the mechanics and physics of the assets that there is a number k of interoperable subsystems represented by the time series signals. The for example, an asset such as commercial jet with k=3 engines as subsystems, an asset such as a motherboard in an enterprise server with k=4 separate processors as subsystems. For use cases where the user knows that number k in advance, existing approaches may be used to subdivide the signals into the k clusters.

Existing clustering algorithms require that the number of clusters k in the collection of time series signals be specified in advance. Otherwise, the existing clustering techniques will start with one large cluster, then progress to 2 clusters that are well-enough correlated in each of the 2 clusters, and progress to 3 clusters that are well-enough correlated in each of the 3 clusters, and so on, progressing to very many tiny clusters. Essentially, if not terminated, existing clustering algorithms will progress to where all of the least correlated signals are in a cluster of one signal each, and the other clusters may contain a small number of signals that happen to have a very high correlation coefficient. Then it is left to user judgement as to how many of the clusters (e.g., 2, 3, . . . , high number) may make sense for an intended application. Without labeling or other knowledge of the relationship of the data, the judgement by the user is essentially a wild guess. Moreover, allowing naïve algorithms to proceed indefinitely into a large number of small clusters destroys the usefulness of the set of signals for subsequent ML anomaly detection analyses: many tiny clusters will individually have very poor Anomaly Detection performance because reduction to tiny clusters discards correlation information about signal behavior (or “dynamics”) in other tiny clusters.

Realistically, datasets are often unlabeled. Thanks to the recent rapid increase in numbers of sensors and the wide variety of uses that the sensors are put to, it is becoming increasingly common that labeling and other knowledge used for determining the number k of component subsystems is simply unavailable or is dissociated from the datasets. This presents a significant barrier to automated clustering. Furthermore, it is common to encounter datasets composed of large quantities of signals, making sorting by a human an impracticable undertaking. For example, a commercial airliner may have more than 75,000 sensors, or an oil refinery may have more than one million sensors, and each sensor producing a time series signal of readings. Determining the proper number of signal groups k is impractical. The number k of component subsystems represented in a collection of time series signals is thus often left undetermined. Leaving K undetermined increases the compute burden of ML anomaly detection, and limits the accuracy of ML anomaly detection models.

In one embodiment, the novel automatic clustering process presented herein solves one or more of the aforementioned challenges by autonomously deriving the correct number k of clusters without requiring labeling. In one embodiment, the automatic clustering process presented herein automatically determines a correct or optimal number k of component subsystems and a size of each signal cluster corresponding to the component subsystems. The automatic clustering process determines the number k of clusters and sizes of clusters from the time series signals themselves based on the degrees of correlation (mutual similarity) between time series signals. The automatically determined k removes the need for a pre-determined k, knowledge of the signal content, or predefined labeling of the signals. This results in datasets with lower dimensionality (smaller memory footprint) for faster throughput and lower latency without diminishing ML modeling accuracy.

In one embodiment, the automatic clustering process presented herein learns correlations between the signals, finds out the correct or optimal number k of clusters to represent the component subsystems, and subdivides the original dataset into smaller groups accordingly. In one embodiment, the automatic clustering process presented herein has the ability to maximize the inter-cluster correlation, which means the signals in each cluster are highly correlated. This presents the additional advantage of enabling downstream analyses that can utilize the correlations. Also, in one embodiment, the automatic clustering process presented herein is compatible with a wide variety of ML anomaly detection techniques. Further, in one embodiment, the automatic clustering process presented herein may employ a wide variety of clustering methods that use an initial input of the k to select the time series signals that make up the k clusters. For example, the automatic clustering process presented herein may use tri-point clustering (TPC) (for example as described in U.S. Pat. No. 9,514,213) or k-medoids clustering methods. As a result, in one embodiment, the automatic clustering process presented herein removes the need for input of the correct number k of clusters.

In one embodiment, the automatic clustering process presented herein automatically clusters unlabeled time series data into an optimal or correct number of clusters to reduce dimensionality of a signal database and thereby decreasing the memory footprint for subsequent ML analyses. In one embodiment, the automatic clustering process presented herein clusters or selects signals for a cluster in such a fashion that each resulting cluster is highly correlated, so that prognostic accuracy is maintained. In one embodiment, the automatic clustering process presented herein detects ambient, global, upstream, or other variables that represent an influence in common on the k component subsystems and their corresponding clusters (referred to collectively herein as “ambient” or “common-influence” variables or time series signals). In one embodiment, the automatic clustering process improves the technology of data clustering by providing autonomous identification of the optimal k clusters without labeling or other input. And, the automatic clustering process improves the technology of data clustering by providing identification of ambient signals that affect all k clusters, and inclusion of copies of the ambient signals in the k clusters. In one embodiment, these features improve ML anomaly detection by causing greater prognostic accuracy and reduced compute load and memory footprint.

One objective of clustering signals is to divide a database of signals into clusters that can be analyzed as separated entities. For conventional clustering of signals, duplicate signals are treated as aberrations to be eliminated. But, elimination of duplicate, common, global, or ambient metrics from the time series database or clusters can substantially reduce prognostic accuracy. The ambient signals (for example, temperature, vibration levels, altitude, relative humidity, radiation levels, etc.) have heretofore been included into only one cluster in which the ambient variable has the statistically highest cross-correlation coefficient. Including a duplicate set of the ambient signals in all k clusters as shown and described herein has been empirically demonstrated to improve the technology of ML prognostic anomaly detection and prognostic maintenance with better prognostic accuracy and earlier detection of anomalies for the ML models trained on and monitoring the k clusters.

In one embodiment, separating the time series signals to into smaller clusters that are specific to an individual machine, asset component, or other signal source (but including the ambient signals) both (1) increases ML accuracy because the “noise” of other signal clusters is excluded from training and surveillance, while including signals for ambient/global influences that would otherwise be scattered among the clusters; and (2) substantially decreases the compute load of using ML models to monitor the signals because the compute load of a multivariate ML model increases with square of the number of input signals. In one embodiment, the automatic clustering process presented herein improves on existing ML surveillance systems by reducing the compute load and memory required for time series anomaly detection without sacrificing prognostic accuracy in terms of false alarm probabilities (FAPs) and missed alarm probabilities (MAPs) for ML prognostic anomaly discovery. In one embodiment, the automatic clustering process presented herein presents an automated clustering method for increasing throughput and processing efficiency without diminishing accuracy for prognostic regression-based ML. In one embodiment, the automated clustering method achieves time-domain clustering of time series signals for use cases where the number of clusters k is not known in advance.

### —Two Phases for Automatic Clustering—

FIG. 3 illustrates another embodiment of an automatic clustering method 300 associated with automatic signal clustering with ambient signals for ML anomaly detection. In one embodiment, as an overview, automatic clustering method 300 includes two major phases or steps. First, automatic clustering method 300 performs a gap statistic analysis of the clusters to identify a number of clusters k. For example, the identified number of clusters k is a “correct” or “optimal” number of clusters that accurately corresponds to the number of machines, asset components, or other sources of correlated time series signals in a time series database. Second, automatic clustering method 300 performs a parametric cross-correlation global (ambient) variable isolation process to identify ambient signals. For example, the ambient signals are those that have a high degree of correlation with signals in other clusters. In one embodiment, both the first phase of gap statistic analysis and the second phase of parametric cross correlation-coefficient global variable isolation work in concert in an overall data-flow framework. In one embodiment, these phases operate to reduce the dimension of the data to be analyzed by individual models, identify highly correlated measurements to improve modeling, and retain globally-relevant measurements that may not be highly correlated.

In one embodiment, automatic clustering method 300 initiates at process block 305 (for example in response to occurrence of one or more of the conditions discussed above for initiation of automatic clustering method 200) and continues to process block 310.

At process block 310, automatic clustering method 300 initializes with an unlabeled signal database. In one embodiment, the unlabeled signal database is “unlabeled” in the sense that the signals are not expressly associated with information that specifies a machine, asset component, signal source, or other group or cluster to which the signal belongs. The unlabeled signal database includes a number of signals M. The signals in the unlabeled signal database are time series signals. The time series signals in the unlabeled signal database have a length, that is, a number of observations N.

At process block 315, automatic clustering method 300 normalizes the time series signals of the unlabeled signal database. In one embodiment, automatic clustering method 300 performs a mean-centered unit variance (MCUV) normalization on the time series signals. The time series signals are adjusted to have a mean of 0 (mean-centered), and a variance of 1 (a unit variance). In one embodiment, the mean of a time series signal is subtracted from the time series signal to center (at 0) the time series signal. In one embodiment, the now mean-centered values of the time series signal are divided by the standard deviation of the mean-centered time series signal to set the standard deviation (and therefore, the variance) to be 1. In one embodiment, this MCUV normalization may be repeated to normalize each time series signal of the unlabeled signal database.

At process block 320, automatic clustering method 300 de-trends the normalized time series signals. In one embodiment, underlying trends that could skew correlation between signals is removed from the normalized time series signals of the unlabeled signal database. In one embodiment, trends are removed by applying a 1st order derivative, utilizing the forward difference method, of each normalized signal. Trends may also be removed with the 1^{st} order derivative in the frequency domain, or Principal Component Analysis, or any other various forms of detrending analysis.

At process block 325, automatic clustering method 300 autonomously identifies a number of clusters k in the normalized, de-trended unlabeled signal database. In one embodiment, the automatic clustering method 300 identifies the number of clusters k with an autonomous time domain clustering process of gap statistic analysis (Process A). Process A is discussed in further detail herein with reference to gap statistic analysis 400 shown in and described with reference to FIG. 4.

In one embodiment, after the completion of process block 325, the unlabeled time series signals in the unlabeled signals database have been separated into k clusters of well-correlated signals. At process block 330, automatic clustering method 300 outputs the k clusters of well-correlated signals, for example by writing the k clusters of time series signals into discrete time series databases for each cluster. Each group or cluster has a number of signals P that is less than the number of signals M in the unlabeled signals database. The number of signals P in a cluster may vary from cluster to cluster, allowing clusters to include differing numbers of time series signals. In one embodiment, the time series signals are not shortened by the clustering process. Accordingly, the time series signals in the k clusters keep the length or number of observations N.

At process block 340, automatic clustering method 300 autonomously identifies ambient signals distributed among the k clusters of time series signals in the normalized, de-trended unlabeled signal database. In one embodiment, automatic clustering method 300 identifies the ambient signals using a parametric cross-correlation global variable isolation process (Process B). Process B is discussed in further detail herein with reference to parametric cross-correlation global variable isolation process 600 shown in and described with reference to FIG. 6.

In one embodiment, at the completion of process block 340, an array of ambient sensor measurements has been gathered. In one embodiment, the array of ambient sensor measurements is an array of time series signals of sensor readings from sensors that are detecting ambient or global phenomena. At process block 345, automatic clustering method 300 outputs the array of ambient sensor measurements. For example, automatic clustering method 300 writes the time series signals in the array of ambient sensor measurements into the discrete time series databases for each cluster.

At the conclusion of process block 345, processing continues to END block 350 where automatic clustering method 300 completes. Following the completion of automatic clustering method 300, the discrete time series databases for each cluster may be used to train individual ML anomaly detection models for monitoring each cluster.

### —First Phase: Gap Statistic Analysis of Clusters—

FIG. 4 illustrates one embodiment of a gap statistic analysis 400 of clusters that is associated with automatic signal clustering with ambient signals for ML anomaly detection. In one embodiment, gap statistic analysis 400 removes the need for domain knowledge or signal labeling to establish the number of clusters k by implementing a numerical method called gap statistics in a clustering algorithm such as TPC or k-medoids. For example, the gap statistics predict the correct number of clusters k by comparing dispersion between ground-truth data and data randomly generated in the same phase space as the ground-truth data. Thus, in one embodiment, the automatic clustering process presented herein the two-step framework autonomously and optimally (i.e., correctly) clusters the time series signals.

Gap statistic analysis 400 commences (in one embodiment, following process block 320 above) at block 405 with access to the normalized and de-trended unlabeled signal database (SDB) of M time series signals of length N observations. In a first branch path 407, gap statistic analysis 400 proceeds to process blocks 410 and 415. At process block 410, gap statistic analysis 400 chooses k clusters from the SDB using a clustering algorithm such as k-medoids (or TPC). At process block 415, gap statistic analysis 400 calculates an intra-cluster (that is, within-cluster) dispersion Wₖ for the k clusters produced by the clustering algorithm.

In one embodiment, intra-cluster dispersion Wₖ is calculated according to Eq. 1 below:

$${W}_{k} = {\sum }_{r = 1}^{k} \frac{1}{2 {n}_{r}} {D}_{r} \qquad Eq . 1$$

where r is an index number for the clusters produced by the clustering algorithm, nᵣ is the number of time series signals in a cluster Cᵣ, and Dᵣ is a cumulative distance between the time series signals in cluster Cᵣ. Cumulative distance Dᵣ between the time series signals in a cluster Cᵣ is calculated according to Eq. 2 below:

$${D}_{r} = {\sum }_{i , {i}^{′} ∈ {C}_{r}} {d}_{i , {i}^{′}} \qquad Eq . 2$$

where i denotes one time series signal in cluster Cᵣ, i′ denotes another time series signal in cluster Cᵣ other than i, and d_{i,i′} is the measure of distance between i and i′. In one embodiment, the measure of distance d_{i,i′} is a correlation coefficient for time series signals i and i′.

In one embodiment, the measure of distance d_{i,i′} between time series signals i and i′ is a shape-based metric for correlation. Note, the metric is based on the convolution integral between a pair of time series signals (such as i and i) and subsequently conducting the correlation function with the convolution integral of signal and itself (i.e., i and i) for the pair of time series signals. (For example, the convolution integral expresses the amount of overlap between signals as one signal is shifted over another signal). Thus, in one embodiment, the measure of distance d_{i,i′} is the correlation between the convolution integral of signals i and i′ and signals i and i. In one embodiment, the shape-based distance d_{i,i′} is a way to conduct a cross-correlation that is independent of the temporal domain. The measure of distance is thus more reliant on a shape of the signal rather than an alignment of the signal, and may therefore be referred to as “shape-based.” In one embodiment, the measure of distance d_{i,i′} between time series signals i and i′ is the Pearson correlation coefficient for time series signals i and i′ and signals i and i.

First branch path 407 is performed iteratively for incrementally increasing values of k clusters. For example, the clustering algorithm chooses clusters from the SDB and calculates intra-cluster dispersions for k=2 clusters, k=3 clusters, . . . , k=K clusters. Here, K is a pre-set, cut-off number of clusters beyond which the number of clusters generated from the SDB is not further increased. Cut-off number K may be set by a user or administrator at a number that is expected to be higher than an actual number of correlated signal sources represented in the SDB. Note that a final selection by gap statistic analysis 400 that the number of clusters k is cut-off number K may indicate that cut-off number K is too low. In one embodiment, gap statistic analysis 400 automatically restarts with a higher value for K where the optimal number of clusters \hat{k} selected by the process is K.

In a second branch path 417, gap statistic analysis 400 generates a null or random dataset where the signals lack actual correlation with each other. In one embodiment, gap statistic analysis 400 prepares one or more random reference signal databases (RRSDBs) and produces expected intra-cluster dispersions W*_{kb} from the RRSDBs for the candidate values of k={1, 2, . . . , K} clusters. The RRSDBs have time series signals that are random noise values that has a probability distribution consistent with corresponding time series signals in the SDB. Comparison of actual intra-cluster dispersions Wₖ generated from the SDB with expected intra-cluster dispersions W*_{kb} generated from the RRSDBs (in second branch path 417) reveals which of the candidate values for k most accurately reflects the number of machines or other signal sources represented in the SDB.

At process block 425, gap statistic analysis 400 compiles average mutual information (AMI) statistic for one of the M time series signals in the SDB. The AMI statistic is a measure of how similar a time series signal is to itself. The AMI identifies the point in the time series signal that deviates the most (also referred to as a most independent point), indicating the onset of a new or repeat pattern in the time series signal. At process block 435, gap statistic analysis 400 determines a lag τ that minimizes autocorrelation—similarity between a time series signal and a copy of the signal that has been delayed by the lag τ—based on the AMI statistics obtained for the time series signal.

As shown at reference 440, gap statistic analysis 400 repeats the steps of compiling the AMI statistics (at process block 425) and determining the lag that minimizes autocorrelation (at process block 435) for each of the M time series signals in the SDB. This loop generates a time point on each time series signal that is an indication of where a pattern of the time series signal begins to repeat itself in its own signal. In other words, the time point indicates the end of one period and the beginning of another period of the time series signal. Following the determination of the lag τ for each of the M time series signals in the SDB, the lag τ is added to a lag array. (The lag array may also be referred to as a trajectory matrix.) At completion of the loop at reference 440, the lag array will include M values for lag τ, with one value for lag r associated with each of the M time series signals in the SDB. The lag array indicates how the M time series signals are related to themselves. At process block 445, the lag array is output, for example by making it available for access by subsequent processing. The lag array may be used to develop random or null case RRSDBs that are more relevant to dependent data than to independent data.

At process block 450, gap statistic analysis 400 initializes a false nearest neighbor (FNN) process using the value for the lag T for one of the M time series signals. The lag τ is used as a delay dimension of the time series signal when reconstructing the time series signal into a phase space. The FNN process then determines an embedded dimension of the time series signal. The FNN process determines the embedded dimension of the time series signal by determining whether distances (such as the L2/Euclidean distance) between observations of the time series signal in the phase space increase with the addition of a dimension. When the distances no longer increase with the addition of further dimensions, the final dimension at which the distances increased is identified as the embedded dimension for the time series signal. As shown at reference 455, gap statistic analysis 400 repeats the steps of initializing the FNN with the value for the lag τ and determining the embedded dimension of the signal for each of the M time series signals in the SDB. The embedded dimension of a time series signal indicates how independent the time series signal is from the other M−1 time series signals.

At process block 460, gap statistic analysis 400 picks a maximum embedded dimension from among the embedded dimensions for the M time series signals, for example by comparing the embedded dimensions for the M time series signals and selecting the one with a highest value. At process block 465, gap statistic analysis 400 then transforms the SDB into a phase or attractor space. Each of the time series in the SDB is reconstructed into a phase space using the lag T as the delay dimension of the transform and the maximum embedded dimension as the embedded dimension of the transform.

At process block 470, gap statistic analysis 400 generates random time series data from the phase space. The gap statistic analysis 400 generates a random reference signal database (RRSDB) from the signal database. The RRDSB includes M random time series signals that are generated from the phase space transformations of the M time series signals in the SDB. The M random time series signals are made up of random values that account for the spatial constraints of the of the phase space transformations of the M time series signals.

At process block 475, gap statistic analysis 400 clusters the M random time series signals in the RRSDB into k={1, 2, . . . , K} clusters, for example as described with reference to process block 410. And, once the clusters of the random time series signals are placed into clusters, at process block 480, gap statistic analysis 400 calculates expected intra-cluster dispersions W*_{kb}, for example as described with reference to process block 415. As shown at reference 485, gap statistic analysis 400 repeats the steps of generating the RRSDB from the phase space, performing the K-medoids with the RRSDB, and calculating the estimated (or expected) intra-cluster dispersions W*_{kb} a number of times B in a Monte Carlo process (with new, randomly sampled values for the RRSDB). B is a pre-selected number of times that allows the expected intra-cluster dispersions W*kb to converge on a value of the dispersion for each k.

At process block 490, gap statistic analysis 400 finds an optimal or “correct” number of clusters \hat{k} using gap statistics. The gap statistics compare the intra-cluster dispersions Wₖ generated from the SDB (in first branch path 407) and the expected (estimated) intra-cluster dispersions W*_{kb} generated from the random reference signal databases (RRSDBs) (in second branch path 417). Because the time series signals in the RRSDBs are random, the expected intra-cluster dispersions W*_{kb} generated from the RRSDBs change in a consistent manner as the candidate value for k is incremented. For example, expected intra-cluster dispersions W*_{kb} of clusters of random noise signals may change at a given rate as the number of clusters k is increased. By comparison, the intra-cluster dispersions Wₖ generated from the SDB change in an inconsistent manner as the candidate value for k is incremented. For example, the intra-cluster dispersions Wₖ of clusters of sensor readings may change piecewise, changing at first rate as the number of clusters k is incremented toward an optimal or “correct” number of clusters \hat{k}, and changing at a second rate as the number of clusters k is incremented away from the optimal number of clusters \hat{k}.

In one embodiment, gap statistic analysis 400 generates the gap statistics for each of the candidate values of k={1, 2, . . . , K} clusters. In one embodiment, the gap statistic G (k) for a number of clusters k is given by Eq. 3 below:

$$G ( k ) = ( \frac{1}{B} ) {\sum }_{b} log ( {W}_{k b}^{*} ) - log ( {W}_{k} ) \qquad Eq . 3$$

where B is a quantity of RRSDBs generated and index number for the RRSDBs b={1, 2, . . . , B}. The gap statistic G(k) describes the gap between actual intra-cluster dispersions Wₖ and expected intra-cluster dispersions W*_{kb}. Thus, the number of clusters k where the gap statistic G (k) is at its greatest indicates the optimal number of clusters \hat{k}. In one embodiment, the number of clusters k for which the gap statistic G(k) is greatest is chosen as the optimal number of clusters \hat{k}. In other words, the optimal or correct number of clusters \hat{k} represented in the SDB is the number of clusters k that has a maximum gap statistic G(k) relative to other values for k. The number of clusters k resulting in the maximum gap statistic G(k) is selected as optimal number of clusters \hat{k}.

FIG. 5 illustrates one example of selection of an optimal or correct number of clusters \hat{k} based on gap statistics. An example set or database of 40 time series signals of equal of equal length includes four groups (that is, clusters) of time series signals with intra-group correlation in behavior. The signals in group numbers 1-4 are concatenated into a single database and treated as unlabeled. Then the signals are analyzed by the gap statistic analysis 400. FIG. 5 shows a chart 500 of results of the autonomous time-domain clustering on the example database. Line 505 is a plot of the gap statistic G(k) for various numbers of clusters k={1,2, . . . , 8} against a number of clusters axis 510 and a gap statistic axis 515. The value of gap statistic G(k) provides a metric for comparing the optimality (that is, the correctness) of partitioning the signals in the example database into differing numbers of clusters k. Maximum point 520 on line 505 is an optimal point at which intra-cluster correlations (that is, correlations between “in-cluster” signals) are maximized and inter-cluster correlations (that is, correlations between signals in different clusters) are minimized. Thus, in one embodiment, gap statistic analysis 400 chooses the optimal number of clusters k by maximizing the gap statistics—the peak in the gap metric defines optimal number of clusters k.

At a ground truth level, the true number of clusters k is 4, as discussed above. The true k 525 is shown by the “x” in plot 500. As discussed above, the gap statistic analysis 400 selects the number of clusters k with the highest gap statistic G(k) to be the optimal number of clusters \hat{k}. The optimal number of clusters \hat{k} selected by the gap statistic analysis algorithm is the maximum point 520 on line 505, which is also at 4. The selected k 530 is shown by the circle in plot 500. The overlap of the true k 525—the ground truth actual value for number of clusters k—and the selected k 530—the optimal value for number of clusters k selected by the gap statistic analysis algorithm-indicates that the gap statistic analysis 400 identifies the correct number of clusters (in this case 4) from the unlabeled data.

Furthermore, the signals placed into each cluster by the gap statistic analysis 400 identically correspond to the signals in each of group numbers 1-4. That is, a first cluster includes signals the signals of group 1, a second cluster includes the signals of group 2, a third cluster includes the signals of group 3, and a fourth cluster includes the signals of group 4.

Referring again to FIG. 4, at process block 495, once the optimal number of clusters k has been determined, gap statistic analysis 400 returns the clusters selected at process block 410 for optimal number of clusters k. Method 300 then resumes at process block 330.

### —Second Phase: Global (Ambient) Variable Isolation—

FIG. 6 illustrates one embodiment of a parametric cross-correlation global variable isolation process 600 that is associated with automatic signal clustering with ambient signals for ML anomaly detection. In one embodiment, the global variable isolation process 600 identifies global (or ambient, upstream, or “common-influence”) variable signals using a parametric cross-correlation analysis.

In one embodiment, at a high level, global variable isolation process 600 analyzes the well-defined clusters to determine the global variable signals by parametrically generating inter-cluster cross-correlation matrices and systematically ranking the correlations. For example, global variable isolation process 600 takes signal #1 of cluster #1 and systematically determines the correlation between it and all of the signals in cluster #2 and then ranks the resulting correlation vector to place the correlations in the vector in order of correlation. The steps of determining correlation between signals and ranking the correlations may be repeated with all combinations of signals and clusters, resulting in a ranked correlation matrix where the signals with the highest inter-cluster correlation are identified.

Copies of all the ambient signals can then be included into each of the k clusters. Thus, a full set of global or ambient signals that represent an influence in common on multiple machines, asset components, or other signal sources represented in the signal database are included in the clusters used for monitoring the machines, asset components, or other signal sources.

Note, global variables that represent a common influence across the signal sources are most commonly ambient variables that represent environmental conditions under which the signal source is operating. As a simple example, an asset such as a large-scale transformer in an electrical utility grid might have 8-12 internal temperature sensors throughout the asset. For assets located outdoors or otherwise operating in uncontrolled environments the variations in ambient temperature can be +/−40 degrees Fahrenheit every 24 hours, and can be an additional +/−40 degrees Fahrenheit on top of daily temperature variation with seasons of the year.

These temperature variations affect all clusters of sensors, even in complex assets that can have thousands of sensors. Conventional clustering algorithms would put an ambient temperature signal into one cluster for which its correlation coefficient happens to be statistically highest, but that sensor would then not be included in all the other k−1 clusters, even though it clearly has some influence with the metrics in those clusters. But, the automatic clustering systems and methods described herein systematically identifies global, ambient, or otherwise “common influence” metrics (for example as shown in global variable isolation process 600), and then duplicates a set of global variables and includes the set of global variables in the k clusters.

Global variable isolation process 600 commences (in one embodiment, following process block 330 above) at block 605 with access to the k clusters (or groups) of well-correlated time series signals. The clusters include P signals. (Note, the number of signals P in a cluster may vary from cluster to cluster, as clusters may include differing cumbers of signals.) The time series signals in the clusters are of length N observations.

At process block 610, global variable isolation process 600 initiates a ranked global influence variable array GlobeVar. In one embodiment, ranked global influence variable array GlobeVar is used for collecting the inter-cluster correlations of signals. In one embodiment, the signals in the ranked global influence variable array GlobeVar are sorted or ranked in order of cross-correlation coefficients. The ranked, inter cluster correlations for the signals in the k clusters are used to determine which signals represent a global influence on the machines, asset components, or other signal sources.

Following process block 610, global variable isolation process 600 analyzes pairs of clusters to determine the extent to which signals in a first cluster in the pair correlate with signals in a second cluster. This pairwise analysis or comparison determines correlation coefficients for inter-cluster pairs of signals, that is, between a time series signal belonging to the first cluster and a time series signal belonging to the second cluster. In one embodiment, the pairwise analysis of the signals performs a set of nested loops to compare each signal in each of the k clusters with each signal in each of the k−1 other clusters.

At process block 615, global variable isolation process 600 initializes an index i for a first cluster Clusterᵢ in a pair of clusters to be analyzed, and sets index i to be equal to 1. Index i indicates which cluster of the k clusters is having signals analyzed for correlation with signals of other clusters of the k clusters.

Decision block 620 provides a base condition of an outermost loop for identifying inter-cluster correlations of the time series signals belonging to the k clusters. The outermost loop repeats k−1 times to use each of k−1 clusters as the first cluster in the pair of clusters to be analyzed. At decision block 620, global variable isolation process 600 determines whether the cluster that is currently selected to be the first cluster Clusterᵢ in the pair is not the second to last of the k clusters. This determination is made, for example, by determining whether index i is less than k−1. If the first cluster in the pair is not the second to last of the k clusters (620: TRUE), the global variable isolation process 600 proceeds to process block 625.

At process block 625, global variable isolation process 600 initiates a ranked cluster influence variable array ClusterVar. In one embodiment, ranked cluster influence variable array ClusterVar is used for collecting the inter-cluster correlations of signals that belong to the first cluster. In one embodiment, an inter-cluster correlation for one signal is recorded as a tuple that includes an identifier for an additional signal (other than the one signal) that belongs to a second cluster (other than the first cluster) and a cross-correlation coefficient between the one signal and the additional signal. The cross-correlation coefficient describes an extent to which a signal belonging to the first cluster correlates with a second signal belonging to another cluster. In one embodiment, the signals in the ranked cluster influence variable array ClusterVar are sorted or ranked in order of cross-correlation coefficients.

At process block 630, global variable isolation process 600 initializes an index j for a second cluster in the pair of clusters to be analyzed. Index j indicates which cluster of the k clusters is having signals analyzed for correlation with signals that belong to the first cluster. Initially, global variable isolation process 600 sets index j to be equal to i+1, indicating the next cluster after the current first cluster. Decision block 635 provides a base condition of a first inner loop (nested within the outermost loop) for identifying inter-cluster correlations of the time series signals belonging to the k clusters. The outermost loop repeats k−i times to use each of k−i clusters that have not already been used as the first cluster to be the second cluster in the pair of clusters to be analyzed. At decision block 635, global variable isolation process 600 determines whether the cluster that is currently selected to be the second cluster Clusterⱼ in the pair is not the last of the k clusters, for example by determining whether index j is less than k. If the second cluster Clusterⱼ in the pair is not the last of the k clusters (635: TRUE), the global variable isolation process 600 proceeds process block 640.

At process block 640, global variable isolation process 600 initializes an index a for a signal belonging to the first cluster. Index a indicates which signal of the signals that belong to the first cluster is being compared with other signals that belong to the second cluster. Initially, global variable isolation process 600 sets index a to be equal to 1, indicating the first time series signal belonging to the first cluster.

Decision block 645 provides a base condition of a second inner loop (nested within the first inner loop) for identifying inter-cluster correlations of the time series signals belonging to the k clusters. In one embodiment, second inner loop repeats for a=1 up to the number of signals Pᵢ belonging to the first cluster, so as to determine inter-cluster correlations for each of the each of the signals Signal_{(1,i)}, . . . , Signal_{(Pi,i)} in the first cluster. The set of inter-cluster correlations will be sorted and appended to the ranked cluster influence variable array ClusterVar. At decision block 645, global variable isolation process 600 determines whether the signal in the first cluster that is currently being analyzed is not the last signal in the first cluster. This determination may be made, for example, by determining whether index a is less than the number of signals belonging to the first cluster, Pᵢ-If the current signal Signal_{(a,i)} (in the first cluster) is not the last signal in the first cluster (645: TRUE), global variable isolation process 600 proceeds to process block 650.

At process block 650, global variable isolation process 600 initializes an index b for a signal belonging to the second cluster. Index b indicates which signal of the signals that belong to the second cluster is being compared with the signal belonging to the first cluster. Initially, global variable isolation process 600 sets index b to be equal to 1, indicating the first time series signal belonging to the second cluster.

Decision block 655 provides a base condition of an innermost loop (nested within the second inner loop) for identifying inter-cluster correlations of the time series signals belonging to the k clusters. In one embodiment, the innermost loop repeats from b=1 up to number of signals Pⱼ belonging to the second cluster, so as to determine an inter-cluster correlation for each of the signals Signal_{(1,j)}, . . . , Signal_{(Pj,j)} in the second cluster with one signal Signal_{(a,i)} in the first cluster. At decision block 655, global variable isolation process 600 determines whether the current second signal is not the last signal in the second cluster, for example, by determining whether index b is less than the number of signals belonging to the second cluster, P₂. If the current signal Signal_{(b,j)} (in the second cluster) is not the last signal in the second cluster (655: TRUE), global variable isolation process 600 proceeds to process block 660.

At process block 660, global variable isolation process 600 calculates the correlation coefficient between a signal belonging to the first cluster, Signal_{(a,i)}, and the second signal belonging to the second cluster, Signal_{(b,j)}. In one embodiment, a cross-correlation coefficient (such as the Pearson correlation coefficient) is calculated for the pair Signal_{(a,i)} and Signal_{(b,j)}. The resulting cross-correlation coefficient is stored for subsequent ranking and inclusion in ranked cluster influence variable array ClusterVar. At process block 665, index b is incremented, and processing returns to decision block 655 to determine whether to repeat or terminate the innermost loop.

If the current signal Signal_{(b,j)} (in the second cluster Cluster) is the last signal in the second cluster (655: FALSE), the innermost loop terminates because there are no further signals in the second cluster Clusterⱼ for which cross-correlation coefficients with Signal_{(a,i)} have not already been found. Global variable isolation process 600 then proceeds to process block 670. At process block 670, global variable isolation process 600 ranks the correlation coefficients that were determined between Signal_{(a,i)} in the first cluster and the signals Signal_{(1,j)}, . . . , Signal_{(Pj,j)} in the second cluster. Then, the ranked correlation coefficients are appended to the ranked cluster influence variable array ClusterVar as an entry for Signal_{(a,i)}. At process block 675, index a is incremented, and processing returns to decision block 645 to determine whether to repeat or terminate the second inner loop.

If the current signal Signal_{(a,i)} (in the first cluster Clusterᵢ) is the last signal in the first cluster (645: FALSE), the second inner loop terminates because there are no further signals in the first cluster Clusterᵢ without a ranked set of correlation coefficients. Global variable isolation process 600 then proceeds to process block 680. At process block 680, global variable isolation process 600 appends the ranked cluster influence variable array ClusterVar to the ranked global influence variable array GlobeVar. At process block 685, index j is incremented, and processing returns to decision block 635 to determine whether to repeat or terminate the first inner loop.

If the second cluster Clusterⱼ in the pair is the last of the k clusters (635: FALSE), the first inner loop terminates because there are no further clusters for analysis against first cluster Clusterᵢ. Global variable isolation process 600 then proceeds to process block 690. At process block 690, index i is incremented, and processing returns to decision block 620 to determine whether to repeat or terminate the outermost loop.

If the first cluster Clusterᵢ in the pair is the second to last of the k clusters (620: FALSE), the outermost loop terminates because there are no further clusters for analysis. At the conclusion of the outermost loop, ranked global influence variable array Globe Var is completely populated. Global variable isolation process 600 then proceeds to process block 693.

At process block 693, global variable isolation process 600 chooses a quantity Q signals from the ranked global influence variable array Globe Var to be the global influence variables (that is, the ambient signals). The Q signals chosen to be the global influence variables are those signals that display high correlation between clusters. The determination may be made based on the highest value of inter-cluster correlation for each signal. For example, the top 5% of signals in terms of top-ranked correlation coefficient with a signal in another cluster may be selected as the global influence variables. At process block 697, once the global influence variables (also referred to as the ambient time series signals) have been selected, global variable isolation process 600 returns the selected global influence variables. Method 300 then resumes at process block 345.

A duplicate of the selected set of ambient time series signals (global influence variables) may then be added to each of the clusters. The clusters, with the complete set of ambient time series signals now included, may be used to train a multivariate ML anomaly detection model and monitor the clusters for anomalies with the trained model. In one embodiment, the ML model trained with these automatically identified and ambient-supplemented clusters of signals achieving increased prognostic accuracy due to the correct correspondence of clusters to signal sources and availability of more complete ambient information-a significant improvement to the technology of anomaly detection.

### Overview of Multivariate ML Anomaly Detection

In general, multivariate ML modeling techniques used for ML anomaly detection predict or estimate what each signal should be or is expected to be based on the other signals in a database or collection of time series signals. The predicted signal may be referred to as the “estimate”. A multivariate ML anomaly detection model is used to make the predictions or estimates for individual variables based on the values provided for other variables. For example, for Signal 1 in a database of N signals, the multivariate ML anomaly detection model will compute an estimate for Signal 1 using signals 2 through N.

In one embodiment, the ML anomaly detection model may be a non-linear non-parametric (NLNP) regression algorithm used for multivariate anomaly detection. Such NLNP regression algorithms include auto-associative kernel regression (AAKR), and similarity-based modeling (SBM) such as the multivariate state estimation technique (MSET) (including Oracle's proprietary Multivariate State Estimation Technique (MSET2)). In one embodiment, the ML anomaly detection model may be another form of algorithm used for multivariate anomaly detection, such as a neural network (NN), Support Vector Machine (SVM), or Linear Regression (LR). In one embodiment, the prognostic performance of each of the foregoing multivariate anomaly detection algorithms may be improved by application of the systems and methods described herein for automatic clustering.

The ML anomaly detection model is trained to produce estimates of what the values of variables should be based on training with time series readings (such as time series vectors or time series signals) that represent normal or correct operation of a monitored asset. To train the ML anomaly detection model, the time series readings are used to adjust the ML anomaly detection model. A configuration of correlation patterns between the variables of the ML anomaly detection model is automatically adjusted based on values of the time series readings so as to cause the ML anomaly detection model to produce accurate estimates for each variable based on inputs to other variables. Sufficient accuracy of estimates to conclude determine the ML anomaly detection model to be sufficiently trained may be determined by residuals—a residual is a difference between an actual value (such as a measured, observed, sampled, or resampled value) and an estimate, reference, or prediction of what the value is expected to be—being minimized below a pre-configured training threshold. At the completion of training, the ML anomaly detection model has learned correlation patterns between variables.

Following training, the ML anomaly detection model may be used to monitor time series readings. Subtracting an actual, measured value for each signal from a corresponding estimate gives the residuals or differences between the values of the signal and estimate. Where there is an anomaly in a signal, the measured signal value departs from the estimated signal value. This causes the residuals to increase, triggering an anomaly alarm. Thus, the residuals are used to detect such anomalies where one or more of the residuals indicates such a departure, for example by becoming consistently excessively large.

For example, the presence of an anomaly may be detected by a sequential probability ratio test (SPRT) analysis of the residuals, as discussed in detail above. In one embodiment, the SPRT calculates a cumulative sum of the log-likelihood ratio for each successive residual between an actual value for a signal and an estimated value for the signal, and compares the cumulative sum against a threshold value indicating anomalous deviation. Where the threshold is crossed, an anomaly is detected, and an alert indicating the anomaly may be generated.

### —Electronic Alerts—

In one embodiment, an electronic alert is generated by composing and transmitting a computer-readable message. The computer readable message may include content describing the anomaly that triggered the alert, such as a time when the anomaly was detected, an indication of the signal value that caused the anomaly, an identification of a cluster (and/or underlying machine, asset component, or other signal source that the cluster represents) for which the anomaly occurred and the alert is applicable. In one embodiment, an electronic alert may be generated and sent in response to a detection of an anomalous signal value. The electronic alert may be composed and then transmitted for subsequent presentation on a display or other action.

In one embodiment, the electronic alert is a message that is configured to be transmitted over a network, such as a wired network, a cellular telephone network, wi-fi network, or other communications infrastructure. The electronic alert may be configured to be read by a computing device. The electronic alert may be configured as a request (such as a REST request) used to trigger initiation of a function in response to detection of an anomaly in a cluster, such as triggering a maintenance response for or reduction of power (e.g., slowdown or shutdown) of the underlying machine, asset component, or other signal source that the cluster represents. In one embodiment, the electronic alert may be presented in a user interface such as a graphical user interface (GUI) by extracting the content of the electronic alert by a REST API that has received the electronic alert. The GUI may present a message, notice, or other indication that the status of operation of a specific machine, asset component, or other signal source has entered (or left) an anomalous state of operation.

In one embodiment, the automatic clustering method thus presents a technical solution that gathering of unlabeled time series signals into clusters of correlated clusters that correspond to discrete machines, asset components, or other signal sources and notifies users when an anomaly occurs in time series signals for a specific machine, asset component, or other source of signals, even where the time series signals are unlabeled as to their source.

### —Cloud or Enterprise Embodiments—

In one embodiment, the present system (such as automatic clustering system 100) is a computing/data processing system including a computing application or collection of distributed computing applications for access and use by other client computing devices that communicate with the present system over a network. In one embodiment, automatic clustering system 100 is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, automatic clustering system 100 is a centralized server-side application that provides at least the functions disclosed herein and that is accessed by many users by way of computing devices/terminals communicating with the computers of automatic clustering system 100 (functioning as one or more servers) over a computer network. In one embodiment automatic clustering system 100 may be implemented by a server or other computing device configured with hardware and software to implement the functions and features described herein.

In one embodiment, the components of automatic clustering system 100 may be implemented as sets of one or more software modules executed by one or more computing devices specially configured for such execution. In one embodiment, the components of automatic clustering system 100 are implemented on one or more hardware computing devices or hosts interconnected by a data network. For example, the components of automatic clustering system 100 may be executed by network-connected computing devices of one or more computer hardware shapes, such as central processing unit (CPU) or general-purpose shapes, dense input/output (I/O) shapes, graphics processing unit (GPU) shapes, and high-performance computing (HPC) shapes.

In one embodiment, the components of automatic clustering system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of automatic clustering system 100 may (i) generate or compose an electronic message or signal to issue a command or request to another component, (ii) transmit the message or signal to other components of automatic clustering system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by automatic clustering system 100, for example through a web interface server. In one embodiment, the remote computing system may send requests to and receive responses from automatic clustering system 100. In one example, access to the information or applications may be effected through use of a web browser on a personal computer or mobile device. In one example, communications exchanged with automatic clustering system 100 may take the form of remote representational state transfer (REST) requests using JavaScript object notation (JSON) as the data interchange format for example, or simple object access protocol (SOAP) requests to and from XML servers. The REST or SOAP requests may include API calls to components of automatic clustering system 100.

### —Software Module Embodiments—

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein.

### —Computing Device Embodiment—

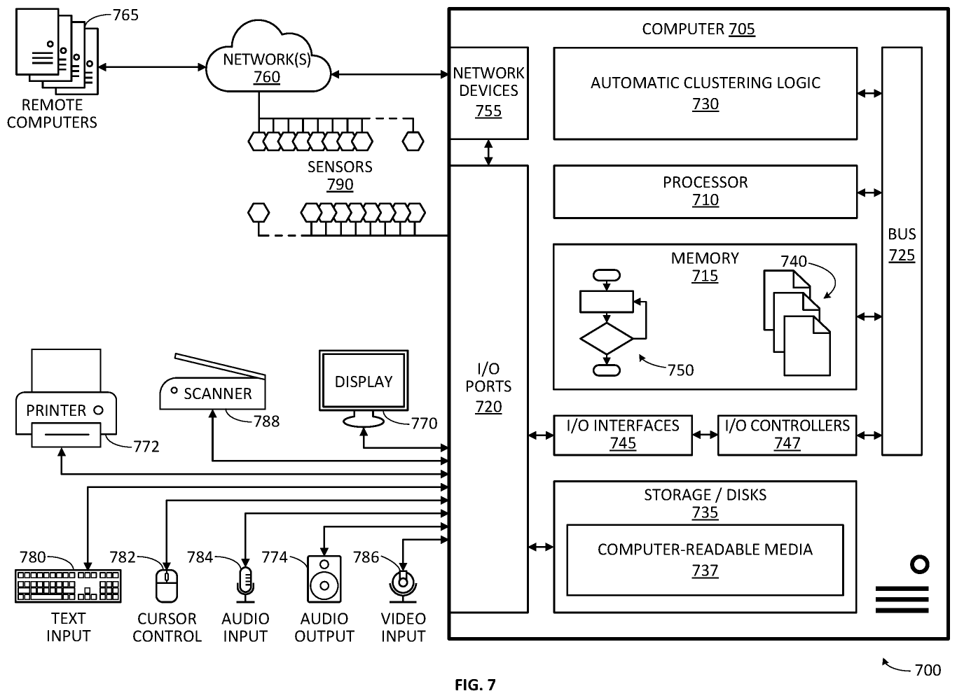

FIG. 7 illustrates an example computing system 700 that is configured and/or programmed as a special purpose computing device(s) with one or more of the example systems and methods described herein, and/or equivalents. The example computing system 700 may include a computer 705 that includes at least one hardware processor 710, a memory 715, and input/output ports 720 operably connected by a bus 725. In one example, the computer 705 may include automatic clustering logic 730 configured to facilitate automatic signal clustering with ambient signals for ML anomaly detection similar to logic, systems, methods, and other embodiments shown in and described with reference to FIGS. 1-3.

In different examples, the logic 730 may be implemented in hardware, a non-transitory computer-readable medium 737 with stored instructions, firmware, and/or combinations thereof. While the logic 730 is illustrated as a hardware component attached to the bus 725, it is to be appreciated that in other embodiments, the logic 730 could be implemented in the processor 710, stored in memory 715, or stored in disk 735.

In one embodiment, logic 730 or the computer 705 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to perform automatic signal clustering with ambient signals for ML anomaly detection. The means may also be implemented as stored computer executable instructions that are presented to computer 705 as data 740 that are temporarily stored in memory 715 and then executed by processor 710.

Logic 730 may also provide means (e.g., hardware, non-transitory computer-readable medium that stores executable instructions, firmware) for performing automatic signal clustering with ambient signals for ML anomaly detection.

Generally describing an example configuration of the computer 705, the processor 710 may be a variety of various processors including dual microprocessor and other multi-processor architectures. A memory 715 may include volatile memory and/or non-volatile memory. Non-volatile memory may include, for example, ROM, PROM, and so on. Volatile memory may include, for example, RAM, SRAM, DRAM, and so on.

A storage disk 735 may be operably connected to the computer 705 via, for example, an input/output (I/O) interface (e.g., card, device) 745 and an input/output port 720 that are controlled by at least an input/output (I/O) controller 747. The disk 735 may be, for example, a magnetic disk drive, a solid-state disk drive, a floppy disk drive, a tape drive, a Zip drive, a flash memory card, a memory stick, and so on. Furthermore, the disk 735 may be a CD-ROM drive, a CD-R drive, a CD-RW drive, a DVD ROM, and so on. The memory 715 can store a process 750 and/or a data 740, for example. The disk 735 and/or the memory 715 can store an operating system that controls and allocates resources of the computer 705.

The computer 705 may interact with, control, and/or be controlled by input/output (I/O) devices via the input/output (I/O) controller 747, the I/O interfaces 745, and the input/output ports 720. Input/output devices may include, for example, one or more displays 770, printers 772 (such as inkjet, laser, or 3D printers), audio output devices 774 (such as speakers or headphones), text input devices 780 (such as keyboards), cursor control devices 782 for pointing and selection inputs (such as mice, trackballs, touch screens, joysticks, pointing sticks, electronic styluses, electronic pen tablets), audio input devices 784 (such as microphones or external audio players), video input devices 786 (such as video and still cameras, or external video players), image scanners 788, video cards (not shown), disks 735, network devices 755, and so on. The input/output ports 720 may include, for example, serial ports, parallel ports, and USB ports.

The computer 705 can operate in a network environment and thus may be connected to the network devices 755 via the I/O interfaces 745, and/or the I/O ports 720. Through the network devices 755, the computer 705 may interact with a network 760. Through the network, the computer 705 may be logically connected to remote computers 765. Networks with which the computer 705 may interact include, but are not limited to, a LAN, a WAN, and other networks.

In one embodiment, the computer may be connected to sensors 790 through I/O ports 720 or networks 760 in order to receive information about physical states of monitored machines, devices, systems, or facilities (collectively referred to as “assets”) and components thereof. In one embodiment, sensors 790 are configured to monitor physical phenomena occurring in or around an asset. The assets generally include any type of machinery or facility with components that perform measurable activities. In one embodiment, sensors 790 may be operably connected or affixed to assets or otherwise configured to detect and monitor physical phenomena occurring in or around the asset. The sensors 790 may produce time series signals of readings taken from the asset. Assets may thus be considered to be sources of the signals (signal sources). The sensors 790 may be network-connected sensors for monitoring any type of physical phenomena. The network connection of the sensors 790 and networks 760 may be wired or wireless.

In one embodiment, the sensors 790 may include (but are not limited to): a temperature sensor, a vibration sensor, an accelerometer, a voltage sensor, a current sensor, a pressure sensor, a rotational speed sensor, a flow meter sensor, a speedometer or other speed sensor, an airspeed sensor or anemometer, a microphone, an electromagnetic radiation sensor, a proximity sensor, a gyroscope, an inclinometer, a global positioning system (GPS) sensor, a fuel gauge, a torque sensor, a flex sensor, a nuclear radiation detector, or any of a wide variety of other sensors or transducers for generating electrical signals that represent sensed physical phenomena, for example physical phenomena occurring in or around an asset.

In one embodiment, computer 705 is configured with logic, such as software modules, to collect readings from sensors 790 and store them as observations in a time series data structure such as a time series database. In one embodiment, the computer 705 polls sensors 790 to retrieve sensor telemetry readings. In one embodiment, the sensor telemetry readings may be a time series of vectors with sensed values for each of sensors 790. In one embodiment, the computer 705 passively receives sensor telemetry readings actively transmitted by sensors 790. In one embodiment, the computer 705 receives one or more collections, sets, or databases of sensor telemetry readings previously collected from sensors 790, for example from storage 735 or from remote computers 765.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (Saas) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method, comprising:
receiving time series signals associated with a plurality of machines, wherein the time series signals are unlabeled as to which of the machines the time series signals are associated with;
automatically determining from the time series signals a plurality of clusters that correspond to the plurality of the machines and separating the time series signals into the plurality of clusters, wherein one cluster of the clusters corresponds to one machine of the plurality of machines and includes the time series signals that are associated with the one machine of the plurality of machines;
identifying a group of ambient time series signals that overlaps more than one of the clusters;
adding the group of the ambient time series signals into the one cluster of the clusters that corresponds to the one machine; and
training a machine learning model to detect an anomaly based on the one cluster to generate a trained machine learning model that is specific to the one machine without using the time series signals not included in the one cluster.

2. The computer-implemented method of claim 1, wherein automatically determining from the time series signals the plurality of clusters that correspond to the plurality of machines further comprises identifying a quantity for the plurality of the clusters at which intra-cluster correlations within the clusters are maximized and inter-cluster correlations between the clusters are minimized.

3. The computer-implemented method of claim 1, wherein automatically determining from the time series signals the plurality of clusters that correspond to the plurality of machines further comprises:
identifying first intra-cluster dispersions in the plurality of clusters based on performing an inverse Fourier transform of a cross power spectral density of a pair of the time series signals to determine a distance between the pair of the time series signals;
generating a gap statistic that indicates a difference between the first intra-cluster dispersions and second intra-cluster dispersions in additional clusters of random noise signals; and
selecting a quantity for the plurality of the clusters at which the gap statistic is maximized.

4. The computer-implemented method of claim 1, wherein identifying the group of ambient time series that overlaps more than one of the clusters further comprises automatically selecting signals from the time series signals that have a correlation between the more than one of the clusters that satisfies a threshold.

5. The computer-implemented method of claim 1, further comprising, for each individual cluster in the plurality of clusters that corresponds to an individual machine:
adding the group of the ambient time series signals to the individual cluster of time series signals associated with the individual machine; and
training a separate machine learning model that is specific to the individual machine that corresponds to the individual cluster, wherein the machine learning model is trained to detect anomalies for the individual machine based on the time series signals from the given cluster and the group of ambient time series signals.

6. The computer-implemented method of claim 1, further comprising:
monitoring the one cluster of the plurality of clusters of the time series signals with the trained machine learning model to detect the anomaly; and
in response to detecting the anomaly in the one cluster of the clusters of the time series signals, generating an electronic alert that the anomaly has occurred for the one machine of the machines that corresponds to the one cluster.

7. The computer-implemented method of claim 1, wherein the ambient time series signals are not produced by the machines.

8. A non-transitory computer-readable medium that includes stored thereon computer-executable instructions that when executed by at least a processor of a computer cause the computer to:
receive time series signals associated with a plurality of sources of the time series signals, wherein the sources that the time series signals are associated with are not identified from labels of the time series signals;
automatically separate the time series signals into a plurality of clusters that corresponding to the plurality of the sources, wherein one cluster of the clusters corresponds to one source of the plurality of sources and includes the time series signals that are associated with the one source of the plurality of sources;
identify a group of ambient time series signals that overlaps more than one of the clusters;
add the group of the ambient time series signals into the one cluster of the clusters that corresponds to the one source; and
train a machine learning model to detect an anomaly based on the one cluster to generate a trained machine learning model that is specific to the one source without using the time series signals not included in the one cluster.

9. The non-transitory computer-readable medium of claim 8, wherein the instructions for automatically separating the time series signals into the plurality of clusters corresponding to the plurality of sources, when executed by at least the processor, further cause the computer to identify a quantity for the plurality of the clusters at which intra-cluster correlations within the clusters are maximized and inter-cluster correlations between the clusters are minimized.

10. The non-transitory computer-readable medium of claim 8, wherein the instructions for automatically separating the time series signals into the plurality of clusters corresponding to the plurality of sources, when executed by at least the processor, further cause the computer to:
identify first intra-cluster dispersions in the plurality of clusters based on performing an inverse Fourier transform of a cross power spectral density of a pair of the time series signals to determine a distance between the pair of the time series signals;
generate a gap statistic that indicates a difference between the first intra-cluster dispersions and second intra-cluster dispersions in additional clusters of random noise signals; and
identify a quantity for the plurality of the clusters at which the gap statistic is maximized.

11. The non-transitory computer-readable medium of claim 8, wherein the instructions for identifying the group of ambient time series that overlaps more than one of the clusters, when executed by at least the processor, further cause the computer to automatically select signals from the time series signals that have a correlation between the more than one of the clusters that satisfies a threshold.

12. The non-transitory computer-readable medium of claim 8, further comprising instructions that when executed by at least the processor cause the computer to, for each individual cluster in the plurality of clusters that corresponds to an individual source:
add the group of the ambient time series signals to the individual cluster of time series signals associated with the individual source; and
train a separate machine learning model that is specific to the individual source that corresponds to the individual cluster, wherein the machine learning model is trained to detect anomalies for the individual source based on the time series signals from the given cluster and the group of ambient time series signals.

13. The non-transitory computer-readable medium of claim 8, further comprising instructions that when executed by at least the processor cause the computer to:
monitor the one cluster of the plurality of clusters of the time series signals with the trained machine learning model to detect the anomaly; and
in response to detecting the anomaly in the one cluster of the clusters of the time series signals, generate an electronic alert that the anomaly has occurred for the one source of the sources that corresponds to the one cluster.

14. The non-transitory computer-readable medium of claim 8, wherein
the ambient time series signals are not produced by the sources.

15. A computing system, comprising:
at least one processor;
at least one memory connected to the at least one processor;
a non-transitory computer readable medium including instructions stored thereon that when executed by at least the processor cause the computing system to:
receive time series signals associated with a plurality of components of an asset, wherein the time series signals are unlabeled as to which of the components the time series signals are associated with;
automatically separate the time series signals into a plurality of clusters corresponding to the plurality of the components, wherein one cluster of the clusters corresponds to one component of the plurality of components and includes the time series signals that are associated with the one component of the plurality of components;
identify a group of ambient time series signals that overlaps more than one of the clusters;
add the group of the ambient time series signals into the one cluster of the clusters that corresponds to the one component; and
train a machine learning model to detect an anomaly based on the one cluster to generate a trained machine learning model that is specific to the one component without using the time series signals not included in the one cluster.

16. The computing system of claim 15, wherein the instructions for automatically separating the time series signals into the plurality of clusters corresponding to the plurality of components further cause the computing system to identify a quantity for the plurality of the clusters at which intra-cluster correlations within the clusters are maximized and inter-cluster correlations between the clusters are minimized.

17. The computing system of claim 15, wherein the instructions for identifying the group of ambient time series that overlaps more than one of the clusters further cause the computing system to automatically select signals from the time series signals that have a correlation between the more than one of the clusters that satisfies a threshold.

18. The computing system of claim 15, wherein the instructions further cause the computing system to, for each individual cluster in the plurality of clusters that corresponds to an individual component:
add the group of the ambient time series signals to the individual cluster of time series signals associated with the individual component; and
train a separate machine learning model that is specific to the individual component that corresponds to the individual cluster, wherein the machine learning model is trained to detect anomalies for the individual component based on the time series signals from the given cluster and the group of ambient time series signals.

19. The computing system of claim 15, wherein the instructions further cause the computing system to:
monitor the one cluster of the plurality of clusters of the time series signals with the trained machine learning model to detect the anomaly; and
in response to detecting the anomaly in the one cluster of the clusters of the time series signals, generate an electronic alert that the anomaly has occurred for the one component of the components that corresponds to the one cluster.

20. The computing system of claim 15, wherein the ambient time series signals are not produced by the components.
